(19) United States
(12) Patent Application Publication
(10) Pub. No.: US 2026/0139185 A1
(43) Pub. Date: May 21, 2026

(54) Particle Comprising Perovskite Core

(71) Applicant: Nanyang Technological University, Singapore (SG)

(72) Inventors: Huajun HE, Singapore (SG); Tze Chien Sum, Singapore (SG)

(21) Appl. No.: 19/395,042

(22) Filed: Nov. 20, 2025

(30) Foreign Application Priority Data
Nov. 21, 2024 (SG) 10202403652Y

(51) Int. Cl. C09K 11/66; C01G 21/00; C09K 11/02

(52) U.S. Cl. CPC C09K 11/665; C01G 21/006; C09K 11/02; C01P 2002/72; C01P 2002/82; C01P 2002/85; C01P 2002/86; C01P 2004/04; C01P 2006/60; C09K 2111/00

(57) ABSTRACT

The present disclosure relates to a particle having a core-shell structure, wherein the core comprises a perovskite compound CsPbX₃, and the shell comprises Csₙ₋₁PbₙX₃ₙ₊₁²⁻ and at least one organic ammonium cation R¹R²R³R⁴N⁺, wherein n is 1 or 2; R¹ is selected from the group consisting of optionally substituted alkyl, optionally substituted alkenyl, optionally substituted alkynyl, optionally substituted aryl, optionally substituted arylalkyl, and optionally substituted heteroaryl; R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl; and X is a halide. The present disclosure also relates to a method of passivating a perovskite compound CsPbX₃, the method comprising the step of: adding an organic ammonium halide R¹R²R³R⁴NY to the CsPbX₃ at a molar ratio of R¹R²R³R⁴NY:CsPbX₃ of about 500:1 to about 60000:1 to form a mixture, wherein R¹ is selected from the group consisting of optionally substituted alkyl, optionally substituted alkenyl, optionally substituted alkynyl, optionally substituted aryl, optionally substituted arylalkyl, and optionally substituted heteroaryl; R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl; and X and Y are independently a halide.

### CROSS-REFERENCE TO RELATED APPLICATIONS

This application claims priority to Singapore application no. 10202403652Y filed with the Intellectual Property Office of Singapore on 21 Nov. 2024, the contents of which is hereby incorporated by reference in its entirety for all purposes.

### TECHNICAL FIELD

The present disclosure generally relates to perovskite compounds, and more particularly relates to particles comprising perovskite compounds. The present disclosure also relates to methods of producing said particles and uses thereof.

### BACKGROUND ART

Nanoparticles in aqueous environment is a highly interdisciplinary frontier field interfacing physics, chemistry and life sciences. These materials have found widespread applications across biology, biotechnology, and medicine, serving as contrast agents in medical imaging, fluorophores in super resolution imaging as well as carriers for gene delivery into cells. Colloidal halide perovskite nanocrystals (HPNCs) recently emerged as a promising nanoparticle family, known for their high brightness (PLQY>90%) and high colour purity with wide colour gamut that exceeds the ITU-R Recommendation BT.2020 standard (Rec. 2020) favourable for applications in displays, lighting and imaging etc. Of late, individual perovskite nanocrystals display high single-photon purity at room temperature that is desirable for quantum information science and technologies as well as for novel optical approaches that enable direct imaging and sensing at the molecular level.

Designing quantum light sources (QLSs) typically requires highly dilute, monodisperse, and high-brightness colloidal nanocrystal systems, commonly achieved in organic phases through advanced surface ligand engineering. However, current water-compatible nanocrystals suffer from low PLQY and significant luminescence quenching upon dilution, preventing the realization of aqueous colloidal nanocrystal-based QLSs and limiting progress in water-based quantum imaging and sensing. Specifically, the inherent moisture instability of conventional perovskite nanocrystals further imposes significant challenges to their deployment as aqueous-based QLSs. While recent advancements have improved the water stability and luminescence of HPNCs (reaching PLQY up to 90% in water) through surface encapsulation techniques using heterogeneous (such as oxides, polymers, and metal sulphides) or homogeneous materials (low-dimensional perovskites or lead halide hydroxides, etc.), these methods face limitations, such as trade-offs between water resistance, hydrophilic-hydrophobic balance, and flexibility in tunning the encapsulation layer. In addition, issues of poor dispersion stability and high-dilution caused luminescence reduction/quenching at the same time. Therefore, developing aqueous HPNCs system that can simultaneously achieve high brightness, stability at high dilution, and mono-dispersibility is essential for advancing molecular-level quantum imaging and sensing.

Thus, there is a need to provide a particle that overcomes, or at least ameliorates one or more of the disadvantages described above, while achieving one or more of high brightness, stability at high dilution, and mono-dispersibility.

### SUMMARY

In an aspect of the present disclosure, there is provided a particle having a core-shell structure, wherein the core comprises a perovskite compound CsPbX₃, and the shell comprises Csₙ₋₁PbₙX₃ₙ₊₁²⁻ and at least one organic ammonium cation R¹R²R³R⁴N⁺,

wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X is a halide.

Advantageously, the particle may possess high emissivity, with a PLQY of ≥80%. The particle may also advantageously possess a high lifetime of up to 21 ns. Further advantageously, the particle may be stable for up to 10300 hours in solvents such as water. Still further advantageously, the particle may possess high zeta potential of 70 mV to 92 mV, which may allow it to exhibit excellent dispersion stability with positively charged surfaces. Still further advantageously, the particle may be stable in acidic conditions. The particle may also maintain high emissivity and stability, and high single-photon purity even at low concentrations of about 0.1 nM. Due to the core-shell structure of the particle, the core may be protected by the shell resulting in minimal degradation, dissolution, and/or decomposition of the CsPbX₃ from the core of the particle.

In another aspect of the present disclosure, there is provided a method of passivating a perovskite compound CsPbX₃, the method comprising the step of
adding an organic ammonium halide R¹R²R³R⁴NY to the CsPbX₃ at a molar ratio of R¹R²R³R⁴NY:CsPbX₃ of about 500:1 to about 60000:1 to form a mixture,
   wherein
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X and Y are independently a halide.

Advantageously, the disclosed method may convert the 3D perovskite CsPbX₃ to a 0D perovskite at the disclosed ratios of organic ammonium halide. This may allow the selective tuning of the 3D perovskite to achieve an optimal ratio of 3D perovskite to 0D perovskite. Still advantageously, the method may be carried out at low temperatures (such as room temperature, or between about 20° C. to about 25° C.), and at atmospheric pressure and conditions. Accordingly, stringent conditions such as high temperature (such as about 100° C. to about 350° C.) or air-free and inert atmosphere protection like in conventional hot-injection methods to synthesize perovskite nanocrystals (such as blue and red emitted ones) can be avoided.

In another aspect of the present disclosure, there is provided a particle having a core shell structure produced by the method as defined herein, wherein the core comprises a perovskite compound CsPbX₃, and the shell comprises Csₙ₋₁PbₙX₃ₙ₊₁²⁻ and at least one organic ammonium cation R¹R²R³R⁴N⁺,
wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X is a halide.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

As used herein, the term “alkyl” includes within its meaning monovalent (“alkyl”) and divalent (“alkylene”) straight chain or branched chain saturated aliphatic groups having from 1 to 20 carbon atoms, e.g., 1, 2, 3, 4, 5, 6, 7, 8, 9, 10, 11, 12, 13, 14, 15, 16, 17, 18, 19 or 20 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, dodecyl, tridecyl, tetradecyl, pentadecyl, hexadecyl, heptadecyl, octadecyl, nonadecyl, icosyl and the like. Alkyl groups may be optionally substituted.

As used herein, the term “alkenyl” includes within its meaning monovalent (“alkenyl”) and divalent (“alkenylene”) straight chain or branched chain unsaturated aliphatic groups containing at least one carbon-carbon double bond and having from 2 to 20 carbon atoms, eg, 2, 3, 4, 5, 6, 7, 8, 9, 10, 11, 12, 13, 14, 15, 16, 17, 18, 19 or 20 carbon atoms. For example, the term alkenyl includes, but is not limited to, ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, 1,5-hexadienyl and the like. Alkenyl groups may be optionally substituted.

As used herein, the term “alkynyl” includes within its meaning monovalent (“alkynyl”) and divalent (“alkynylene”) unsaturated aliphatic groups containing at least one carbon-carbon triple bond and having from 2 to 20 carbon atoms, eg, 2, 3, 4, 5, 6, 7, 8, 9, 10, 11, 12, 13, 14, 15, 16, 17, 18, 19 or 20 carbon atoms. For example, the term alkynyl includes, but is not limited to, ethynyl, propynyl, 1-butynyl, 2-butynyl, 1-pentynyl, 2-pentynyl, 1-hexynyl, 2-hexynyl, 3-hexynyl, 3-methyl-1-pentynyl, and the like. Alkynyl groups may be optionally substituted.

The term “aryl”, or variants such as “aromatic group” or “arylene” as used herein refers to monovalent (“aryl”) and divalent (“arylene”) single, polynuclear, conjugated and fused residues of aromatic hydrocarbons having from 6 to 10 carbon atoms. Such groups include, for example, phenyl, biphenyl, naphthyl, phenanthrenyl, and the like. Aryl groups may be optionally substituted.

When compounded chemical names, e.g. “arylalkyl” are used herein, they are understood to have a specific connectivity to the nitrogen atom of the ammonium cation. The group listed farthest to the right (e.g. alkyl in “arylalkyl”), is the group that is directly connected to the nitrogen atom. Thus, an “arylalkyl” group, for example, is an alkyl group substituted with an aryl group (e.g. phenylmethyl (i.e., benzyl)) and the alkyl group is attached to the nitrogen atom. An “alkylaryl” group is an aryl group substituted with an alkyl group (e.g., p-methylphenyl (i.e., p-tolyl)) and the aryl group is attached to the nitrogen atom.

The term “optionally substituted” as used herein means the group to which this term refers may be unsubstituted, or may be substituted with one or more groups other than hydrogen, provided that the indicated atom's normal valency is not exceeded, and that the substitution results in a stable compound. Such groups may be, for example, halogen, hydroxy, alkyl, alkoxy, haloalkyl, haloalkoxy, alkylthio, hydroxyalkyl, alkoxyalkyl, cycloalkyl, cycloalkylalkoxy, aryl, arylalkyl, alkylaminoalkyl, a group R^{x}R^{y}N—, (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1

FIG. 1 is a diagram showing the comparison between a comparative embodiment and an embodiment of the present invention.

FIG. 2A

FIG. 2A is a spectrum showing the absorption and photoluminescence (PL) of the 3D phase of an embodiment of the present invention dispersed in hexane.

FIG. 2B

FIG. 2B is a pair of digital photographs of the 3D phase of the embodiment of FIG. 2A under bright field (BF) and PL upon 365 nm excitation.

FIG. 2C

FIG. 2C is a CIE spectrum of an embodiment of the 3D phase of the embodiment of FIG. 2A dispersed in hexane.

FIG. 2D

FIG. 2D is a 2D pseudo-colour transient absorption (TA) plot of the 3D phase of the embodiment of FIG. 2A dispersed in hexane.

FIG. 2E

FIG. 2E is a series of pump fluence dependent TA spectra of the 3D phase of the embodiment of FIG. 2A dispersed in hexane, in the region of bleaching signal at the delay time of 1000 ps, with excitation wavelength at 400 nm.

FIG. 2F

FIG. 2F is a graph showing the |DOD| as the function of photon fluence for 400 nm excitation at the delay time of 1000 ps for the 3D phase of the embodiment of FIG. 2A.

FIG. 3A

FIG. 3A is a series of absorbance spectra of the 3D phase of embodiments of the present invention obtained by three reagent combinations.

FIG. 3B

FIG. 3B is a series of photoluminescence excitation (PLE) and PL spectra of the 3D phase of the embodiments of FIG. 3A.

FIG. 4A

FIG. 4A is a series of absorption and PL spectra of the 3D and 0D phases of an embodiment of the present invention.

FIG. 4B

FIG. 4B is a schematic of the crystal structures of the two phases of the embodiment of FIG. 4A.

FIG. 4C

FIG. 4C is a series of powder X-ray diffraction (PXRD) spectra of the two phases of the embodiment of FIG. 4A.

FIG. 4D

FIG. 4D is a series of absorption spectra of embodiments of the present invention with varying amounts of OAmBr treatment.

FIG. 4E

FIG. 4E is a series of PL spectra of the embodiments of FIG. 4D.

FIG. 4F

FIG. 4F is a series of spectra showing the normalized absorbance at 504 nm and 314 nm of the embodiments of FIG. 4D.

FIG. 4G

FIG. 4G is a schematic showing the morphological transformation between the embodiments of FIG. 4D.

FIG. 4H

FIG. 4H is a transmission electron microscope (TEM) image showing the morphology of an embodiment of FIG. 4D at a 20 nm scale, where the OAmBr/nanocrystal ratio is 287.4.

FIG. 4I

FIG. 4I is a TEM image showing the morphology of an embodiment of FIG. 4D at a 20 nm scale, where the OAmBr/nanocrystal ratio is 5747.

FIG. 4J

FIG. 4J is a TEM image showing the morphology of an embodiment of FIG. 4D at a 20 nm scale, where the OAmBr/nanocrystal ratio is 28736.

FIG. 4K

FIG. 4K is a series of PLQY spectra of the embodiments of FIG. 4D before and after purification.

FIG. 5A

FIG. 5A is a TEM image of the 3D phase of an embodiment of the present invention at 50 nm scale.

FIG. 5B

FIG. 5B is a high-resolution TEM image of the embodiment of FIG. 5A viewed along the [101] zone axis, the inset showing the associated Fast Fourier Transform (FFT) pattern of the embodiment at 2 nm⁻¹ scale.

FIG. 5C

FIG. 5C is a graph showing the edge length distributions of the embodiment of FIG. 5A.

FIG. 5D

FIG. 5D is a TEM image of the 0D phase of an embodiment of the present invention at 50 nm scale.

FIG. 5E

FIG. 5E is a high-resolution TEM image of the embodiment of FIG. 5D viewed along the [104] zone axis, the inset showing the associated Fast Fourier Transform (FFT) pattern of the embodiment at 2 nm⁻¹ scale.

FIG. 5F

FIG. 5F is a graph showing the edge length distributions of the embodiment of FIG. 5D.

FIG. 6A

FIG. 6A is a series of absorption spectra of the precipitate dispersed in hexane after purification of the embodiments of FIG. 4D.

FIG. 6B

FIG. 6B is a series of PL spectra of the precipitate dispersed in hexane after purification of the embodiments of FIG. 4D.

FIG. 6C

FIG. 6C is a series of absorption spectra of the supernatant after purification of the embodiments of FIG. 4D.

FIG. 6D

FIG. 6D is a series of absorption spectra of the supernatant after purification of the embodiments of FIG. 4D.

FIG. 6E

FIG. 6E is a series of PXRD patterns of embodiments of the present invention (Rₘ≈287.4, 1,437 and 5,747)

FIG. 6F

FIG. 6F is a series of Fourier-Transform Infrared (FTIR) spectra of a reactant and embodiments of the present invention.

FIG. 7A

FIG. 7A is a series of absorption spectra of embodiments of the present invention dispersed in water.

FIG. 7B

FIG. 7B is a series of PL spectra of the embodiments of FIG. 7A.

FIG. 7C

FIG. 7C is a series of graphs showing the PLQY and average PL lifetime of the embodiments of FIG. 7A upon excitation at 450 nm.

FIG. 7D

FIG. 7D is a series of digital images of the embodiments of FIG. 7A upon excitation at 365 nm.

FIG. 7E

FIG. 7E is a graph showing the dispersion time correlated PLQY of an embodiment of the present invention with excitation at 450 nm at room temperature.

FIG. 7F

FIG. 7F is a graph showing the zeta potentials of embodiments of the present invention after dispersion in water.

FIG. 7G

FIG. 7G is a TEM image of an embodiment of the present invention in an aqueous environment at 50 nm scale.

FIG. 7H

FIG. 7H is a schematic showing the structure of FIG. 7G.

FIG. 8

FIG. 8 is a series of TRPL plots and fitting curves of embodiments of the present invention.

FIG. 9A

FIG. 9A is a series of absorbance spectra of embodiments of the present invention obtained from three different batches.

FIG. 9B

FIG. 9B is a series of photoluminescence excitation (PLE) and PL spectral analysis of the embodiments of FIG. 9A.

FIG. 10A

FIG. 10A is a series of absorption spectra of an embodiment of the present invention dispersed in water at different dispersion times.

FIG. 10B

FIG. 10B is a series of PL spectra of the embodiment of FIG. 10A at different dispersion times.

FIG. 10C

FIG. 10C is a pair of graphs showing the dispersion time dependent normalized PL peak intensity and absorption at 500 nm of the embodiment of FIG. 10A.

FIG. 10D

FIG. 10D is a graph showing the dispersion time dependent PLQY of the embodiment of FIG. 10A.

FIG. 10E

FIG. 10E is a graph showing PL peak position of the embodiment of FIG. 10A.

FIG. 10F

FIG. 10F is a CIE spectrum showing the spectral changes of the embodiment of FIG. 10A with increasing dispersion time.

FIG. 11A

FIG. 11A is a digital image of a comparative embodiment under BF.

FIG. 11B

FIG. 11B is a digital image of the comparative embodiment of FIG. 11A upon 365 nm excitation.

FIG. 11C

FIG. 11C is a digital image of an embodiment of the present invention under BF.

FIG. 11D

FIG. 11D is a digital image of the embodiment of FIG. 11C upon 365 nm excitation.

FIG. 12A

FIG. 12A is a TEM image of an embodiment of the present invention taken at 200 kV at 50 nm scale.

FIG. 12B

FIG. 12B is a TEM image of the embodiment of FIG. 12A taken at 200 kV at 50 nm scale.

FIG. 12C

FIG. 12C is a TEM image of the embodiment of FIG. 12A taken at 200 kV at 50 nm scale.

FIG. 13A

FIG. 13A is a HRTEM image of the 3D phase of an embodiment of the present invention after water evaporation at 20 nm scale.

FIG. 13B

FIG. 13B is a HRTEM image of the embodiment of FIG. 13A at 20 nm scale.

FIG. 13C

FIG. 13C is an FFT image showing the FFT pattern of the embodiment of FIG. 13A at 2 nm⁻¹ scale.

FIG. 14A

FIG. 14A is a TEM image of the 2D layered structure of an embodiment of the present invention at 20 nm scale.

FIG. 14B

FIG. 14B is a TEM image of the embodiment of FIG. 14A at 20 nm scale.

FIG. 14C

FIG. 14C is a graph showing the corresponding distance measurements of the embodiment of FIG. 14A.

FIG. 14D

FIG. 14D is a graph showing the corresponding distance measurements of the embodiment of FIG. 14B.

FIG. 15A

FIG. 15A is an overlay of scanning transmission electron microscopy (STEM) and energy dispersive X-ray (EDX) mapping of Cs in an embodiment of the present disclosure at 50 nm scale.

FIG. 15B

FIG. 15B is an overlay of STEM and EDX mapping of Pb in the embodiment of FIG. 15A at 50 nm scale.

FIG. 15C

FIG. 15C is an overlay of STEM and EDX mapping of Br in the embodiment of FIG. 15A at 50 nm scale.

FIG. 15D

FIG. 15D is an EDX spectrum of the embodiment of FIG. 15A.

FIG. 16A

FIG. 16A is a series of PXRD patterns of embodiments of the present invention.

FIG. 16B

FIG. 16B is a series of absorption and PL spectra of an embodiment of FIG. 16A after water evaporation.

FIG. 17

FIG. 17 is a diagram showing the absorption analysis of an embodiment of the present invention at about 4° C. storage.

FIG. 18A

FIG. 18A is the ¹H NMR prediction of a reagent (OAm⁺ cation) dissolved in DMSO-d₆.

FIG. 18B

FIG. 18B is a series of ¹H NMR spectra of the reagent of FIG. 18A in D₂O and DMSO-d₆, and an embodiment of the present invention dissolved in D₂O.

FIG. 18C

FIG. 18C is a zoomed-in view of the spectrum of FIG. 18B.

FIG. 19A

FIG. 19A is a series of absorption spectra of an embodiment of the present invention at different pH.

FIG. 19B

FIG. 19B is a series of PL spectra of the embodiment of FIG. 19A at different pH.

FIG. 19C

FIG. 19C is a series of digital images of the embodiment of FIG. 19A under BF and 365 nm excitation.

FIG. 19D

FIG. 19D is a graph showing the PLQY measurements of the embodiment of FIG. 19A at different pH.

FIG. 20A

FIG. 20A is a pair of digital images of an embodiment of the invention under BF and 365 nm excitation.

FIG. 20B

FIG. 20B is a pair of digital images showing a 100× dilution of the embodiment of FIG. 20A with 0.1 M HBr solution under BF and 365 nm excitation.

FIG. 20C

FIG. 20C is a pair of digital images showing a 100× dilution of the embodiment of FIG. 20A with water under BF and 365 nm excitation.

FIG. 20D

FIG. 20D is a series of absorption spectra of the embodiments of FIGS. 20A to 20C.

FIG. 20E

FIG. 20E is a series of PL spectra of the embodiments of FIGS. 20A to 20C.

FIG. 21A

FIG. 21A is a schematic of the solution phase photon correlation (S-g⁽²⁾) experiment.

FIG. 21B

FIG. 21B is a pair of digital images showing the BF and PL (under 365 nm excitation) before and after about 2000× dilution of an embodiment of the present invention with 0.1 M HBr solution.

FIG. 21C

FIG. 21C is a PL spectral comparison before and after about 2000× dilution of the embodiment of FIG. 21B with 0.1 M HBr solution.

FIG. 21D

FIG. 21D is a spectrum showing the PL stability of the embodiment of FIG. 21B after dilution.

FIG. 21E

FIG. 21E is a spectrum showing the narrow PL full width at half maximum (FWHM) of the embodiment of FIG. 21B after dilution.

FIG. 21F

FIG. 21F is a graph showing the second-order correlation function g⁽²⁾ (τ) of the embodiment of FIG. 21B.

FIG. 21G

FIG. 21G is a graph showing the average value of the function of FIG. 21F at zero delay time.

FIG. 22A

FIG. 22A is a pair of BF and PL digital images of an embodiment of the present invention before treatment.

FIG. 22B

FIG. 22B is a series of absorption and PL spectra of the embodiment of FIG. 22A.

FIG. 22C

FIG. 22C is a TEM image of the embodiment of FIG. 22A at 20 nm scale, the inset showing the average edge lengths of said embodiment.

FIG. 22D

FIG. 22D is a series of absorption and PL spectra of the embodiment of FIG. 22A after treatment.

FIG. 23A

FIG. 23A is a spectrum showing the PL stability of an embodiment of the present invention.

FIG. 23B

FIG. 23B is a spectrum showing the PL stability of an embodiment of the present invention.

FIG. 24A

FIG. 24A is a spectrum showing the solution phase g⁽²⁾ test of an embodiment of the present invention.

FIG. 24B

FIG. 24B is a spectrum showing the solution phase g⁽²⁾ test of an embodiment of the present invention.

FIG. 24C

FIG. 24C is a spectrum showing the solution phase g⁽²⁾ test of an embodiment of the present invention.

FIG. 24D

FIG. 24D is a spectrum showing the solution phase g⁽²⁾ test of an embodiment of the present invention.

FIG. 24E

FIG. 24E is a spectrum showing the solution phase g⁽²⁾ test of an embodiment of the present invention.

FIG. 24F

FIG. 24F is a spectrum showing the solution phase g⁽²⁾ test of an embodiment of the present invention.

FIG. 24G

FIG. 24G is a spectrum showing the solution phase g⁽²⁾ test of an embodiment of the present invention.

FIG. 24H

FIG. 24H is a spectrum showing the solution phase g⁽²⁾ test of an embodiment of the present invention.

FIG. 24I

FIG. 24I is a spectrum showing the solution phase g⁽²⁾ test of an embodiment of the present invention.

FIG. 24J

FIG. 24J is a spectrum showing the solution phase g⁽²⁾ test of an embodiment of the present invention.

FIG. 25A

FIG. 25A is a graph showing the variation in the concentration of Cs⁺ over time in an embodiment of the present invention.

FIG. 25B

FIG. 25B is a graph showing the variation in the concentration of Pb²⁺ over time in an embodiment of the present invention.

FIG. 26A

FIG. 26A is a series of absorption spectra of embodiments of the present invention before purification.

FIG. 26B

FIG. 26B is a series of absorption spectra of embodiments of the present invention after dispersion in water.

FIG. 27A

FIG. 27A is a series of PL spectra of embodiments of the present invention.

FIG. 27B

FIG. 27B is a CIE spectrum of the embodiments of FIG. 27A.

FIG. 27C

FIG. 27C is a digital image of the PL of the embodiments of FIG. 27A.

FIG. 27D

FIG. 27D is a graph showing the zeta potential measurements of the embodiments of FIG. 27A.

FIG. 27E

FIG. 27E is a graph showing a comparison of the spectral features of the embodiments of FIG. 27A and comparative embodiments.

FIG. 27F

FIG. 27F is a graph showing a PLQY comparison of the embodiments of FIG. 27A and comparative embodiments.

FIG. 28A

FIG. 28A is a spectrum showing the PL stability test of an embodiment of the present invention.

FIG. 28B

FIG. 28B is a spectrum showing the preliminary solution phase g⁽²⁾ test of the embodiment of FIG. 28A.

### DETAILED DISCLOSURE OF EMBODIMENTS

Exemplary, non-limiting embodiments of a particle will now be disclosed.

Provided herein is a particle having a core-shell structure, wherein the core comprises a perovskite compound CsPbX₃, and the shell comprises Csₙ₋₁PbₙX₃ₙ₊₁²⁻ and at least one organic ammonium cation R¹R²R³R⁴N⁺,

wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl; and
X is a halide.

Advantageously, the particle may possess high emissivity, with a PLQY of ≥80%. The particle may also advantageously possess a high lifetime of up to 21 ns. Further advantageously, the particle may be stable for up to 10300 hours in solvents such as water. Still further advantageously, the particle may possess high zeta potential of 70-92 mV, which may allow it to exhibit excellent dispersion stability with positively charged surfaces. Still further advantageously, the particle may be stable in acidic conditions. The particle may also maintain high emissivity and stability, and high single-photon purity even at low concentrations of about 0.1 nM. The core may be protected by the shell to minimise degradation, dissolution, and/or decomposition of the CsPbX₃ from the core of the particle. The surface of the core may be passivated by the shell.

The perovskite compound CsPbX₃ may have a size in a range of from about 10 nm to about 21 nm, 10 nm to about 20 nm, from about 10 nm to about 19 nm, from about 10 nm to about 18 nm, from about 10 nm to about 17 nm, from about 10 nm to about 16 nm, from about 10 nm to about 15 nm, from about 10 nm to about 14 nm, from about 10 nm to about 13 nm, from about 10 nm to about 12 nm, from about 10 nm to about 11 nm, or from about 11 nm to about 21 nm, from about 12 nm to about 21 nm, from about 13 nm to about 21 nm, from about 14 nm to about 21 nm, from about 15 nm to about 21 nm, from about 16 nm to about 21 nm, from about 17 nm to about 21 nm, from about 18 nm to about 21 nm, from about 19 nm to about 21 nm, from about 20 nm to about 21 nm, or about 10 nm, about 11 nm, about 12 nm, about 13 nm, about 14 nm, about 15 nm, about 16 nm, about 17 nm, about 18 nm, about 19 nm, about 20 nm, about 21 nm, or any value or range therein. It is to be appreciated that the above ranges should be interpreted as including and supporting any sub-ranges or discrete values (which may or may not be a whole number) that are within the stated range(s). When the perovskite compound has a size in the disclosed range, it may advantageously allow the adjustment of the multiexciton recombination process, which may advantageously allow the single photon emission or stimulated emission properties of the particle to be carefully and selectively tuned.

The perovskite compound CsPbX₃ may be in the form of a nanocrystal. The perovskite compound CsPbX₃ may also be in the form of thin films, microcrystals, bulk single crystals, and the like.

The organic ammonium cation may be present as a bilayer in the shell. The shell may comprise a perovskite compound, such as a Ruddlesden-Popper perovskite (RPP), having a formula of (R¹R²R³R⁴N)₂Csₙ₋₁PbₙX₃ₙ₊₁, where n is as defined above and denotes the number of Pb—X octahedral monolayers.

Where R², R³, or R⁴ is not —H, R¹, R², R³, R⁴ may independently be selected from moieties that form bilayer structures. For example, any of R¹, R², R³, R⁴ may independently be a long chain alkyl, or aryl groups that favour π-stacking, or cation-π interactions. Any of R¹, R², R³, R⁴ may independently be cis-9-octadecen-1-yl, phenethyl, benzyl, or naphthylmethyl.

R¹ may be selected from the group consisting of cis-9-octadecen-1-yl, phenethyl, benzyl, or naphthylmethyl; and R², R³, R⁴ may each be independently selected from the group consisting of —H, cis-9-octadecen-1-yl, phenethyl, benzyl, or naphthylmethyl.

Advantageously, when the organic ammonium cation is present in excess when compared to the CsPbX₃, the CsPbX₃ may be converted from a 3D perovskite to a 0D perovskite. The 0D perovskite may have the structure Cs₄PbX₆. The 0D perovskite may advantageously possess high ion diffusion properties.

The conversion of a 3D perovskite to a 0D perovskite may take place via the following reaction:

$$4 {CsPb X}_{3} + 6 {R}^{1} {R}^{2} {R}^{3} {R}^{4} N X \to {Cs}_{4} Pb {X}_{6} + 3 {( {R}^{1} {R}^{2} {R}^{3} {R}^{4} N X )}_{2} [ {Pb X}_{2} ]$$

The 0D perovskite may decompose in a solvent via the following reaction:

$${Cs}_{4} Pb {X}_{6} + 2 {R}^{1} {R}^{2} {R}^{3} {R}^{4} N X \to {( {R}^{1} {R}^{2} {R}^{3} {R}^{4} N )}_{2} [ {Pb X}_{4} ] + 4 {Cs}^{+} + 4 {X}^{-}$$

The (R¹R²R³R⁴N)₂[PbX₄] may dissociate in the solvent to provide R¹R²R³R⁴N⁺ and [PbX₄]²⁻ ions.

In some embodiments, at high concentrations of [PbX₄]²⁻, the following reaction may occur:

$${( {R}^{1} {R}^{2} {R}^{3} {R}^{4} N )}_{2} [ {Pb X}_{4} ] + {CsPb X}_{3} \to {( {R}^{1} {R}^{2} {R}^{3} {R}^{4} N )}_{2} {CsPb}_{2} {X}_{7}$$

The shell may have a configuration of R¹R²R³R⁴N⁺ bilayer|Csₙ₋₁PbₙX₃ₙ₊₁²⁻|R¹R²R³R⁴N⁺ bilayer. The disclosed (R¹R²R³R⁴N)₂Csₙ₋₁PbₙX₃ₙ₊₁² may spontaneously assemble around the core to form the above configuration. Advantageously, the shell having the disclosed configuration may passivate the core comprising the 3D perovskite. This passivation may occur by suppressing non-radiative transitions caused by surface defects. The shell structure may also minimize high surface energy associated with hydrophobic ends of organic ammonium cation chains. Where R², R³, and R⁴ are H, the exposed —NH₃⁺ groups of the bilayers may render the surface of the particle positively charged, which may advantageously provide good passivation and protection to the core. This may advantageously allow the particle to exhibit high dispersion stability and/or dispersity due to the positive charges on the surface of the particle.

The Csₙ₋₁PbₙX₃ₙ₊₁²⁻ structure in the disclosed configuration of R¹R²R³R⁴N⁺ bilayer|Csₙ₋₁PbₙX₃ₙ₊₁²⁻ R¹R²R³R⁴N⁺ bilayer may be present as a single layer (n=1) or a double layer (n=2). The Csₙ₋₁PbₙX₃ₙ₊₁²⁻ structure may have a thickness in a range of from about 0.7 nm to about 1.4 nm, from about 0.7 nm to about 1.3 nm, from about 0.7 nm to about 1.2 nm, from about 0.7 nm to about 1.1 nm, from about 0.7 nm to about 1.0 nm, from about 0.7 nm to about 0.9 nm, from about 0.7 nm to about 0.8 nm, or from about 0.8 nm to about 1.4 nm, from about 0.9 nm to about 1.4 nm, from about 1.0 nm to about 1.4 nm, from about 1.1 nm to about 1.4 nm, from about 1.2 nm to about 1.4 nm, from about 1.3 nm to about 1.4 nm, or about 0.7 nm, about 0.8 nm, about 0.9 nm, about 1.0 nm, about 1.1 nm, about 1.2 nm, about 1.3 nm, about 1.4 nm, or any value or range therein. It is to be appreciated that the above ranges should be interpreted as including and supporting any sub-ranges or discrete values (which may or may not be a whole number) that are within the stated range(s).

The shell may comprise a single (R¹R²R³R⁴N⁺ bilayer|Csₙ₋₁PbX₃ₙ₊₁²⁻|R¹R²R³R⁴N⁺ bilayer) structure. The shell may comprise repeating units of (R¹R²R³R⁴N⁺ bilayer|Csₙ₋₁PbₙX₃ₙ₊₁²⁻|R¹R²R³R⁴N⁺ bilayer|Csₙ₋₁PbₙX₃ₙ₊₁²⁻| . . . |R¹R²R³R⁴N⁺ bilayer). The shell thickness may be in a range of from about 5 nm to about 50 nm, from about 5 nm to about 45 nm, from about 5 nm to about 40 nm, from about 5 nm to about 35 nm, from about 5 nm to about 30 nm, from about 5 nm to about 25 nm, from about 5 nm to about 20 nm, from about 5 nm to about 15 nm, from about 5 nm to about 10 nm, from about 5 nm to about 7.9 nm, from about 5 nm to about 6.5 nm, or from about 6.5 nm to about 50 nm, from about 7.9 nm to about 50 nm, from about 10 nm to about 50 nm, from about 15 nm to about 50 nm, from about 20 nm to about 50 nm, from about 25 nm to about 50 nm, from about 30 nm to about 50 nm, from about 35 nm to about 50 nm, from about 40 nm to about 50 nm, from about 45 nm to about 50 nm, or about 5 nm, about 6.5 nm, about 7.9 nm, about 10 nm, about 15 nm, about 20 nm, about 25 nm, about 30 nm, about 35 nm, about 40 nm, about 45 nm, about 50 nm, or any value or range therein. It is to be appreciated that the above ranges should be interpreted as including and supporting any sub-ranges or discrete values (which may or may not be a whole number) that are within the stated range(s).

The particle may be dispersed in a polar protic solvent. The solvent may be water. When the particle is dispersed in water, any present 0D perovskite may transform into the disclosed shell structure comprising Csₙ₋₁PbₙX₃ₙ₊₁²⁻ and at least one organic ammonium cation, which then at least partially or fully encapsulates the core forming the core-shell structure. This may advantageously allow water-sensitive 3D perovskites to maintain their emissivity even when dispersed in water or an aqueous environment as the 3D perovskites remain in the core of the particle.

The particle may be dispersed in a solvent at a concentration in a range of from about 0.1 nM to about 1000 nM, from about 0.1 nM to about 500 nM, from about 0.1 nM to about 348 nM, from about 0.1 nM to about 200 nM, from about 0.1 nM to about 100 nM, from about 0.1 nM to about 10 nM, from about 0.1 nM to about 1.2 nM, from about 0.1 nM to about 1.0 nM, or from about 1.0 nM to about 1000 nM, from about 1.2 nM to about 1000 nM, from about 10 nM to about 1000 nM, from about 100 nM to about 1000 nM, from about 200 nM to about 1000 nM, from about 348 nM to about 1000 nM, from about 500 nM to about 1000 nM, or about 0.1 nM, about 1.0 nM, about 1.2 nM, about 10 nM, about 100 nM, about 200 nM, about 348 nM, about 500 nM, about 1000 nM, or any value or range therein. It is to be appreciated that the above ranges should be interpreted as including and supporting any sub-ranges or discrete values (which may or may not be a whole number) that are within the stated range(s). The solvent may be a polar protic solvent. The solvent may be water.

The CsPbX₃ and the Csₙ₋₁PbₙX₃ₙ₊₁²⁻ may be present in a molar ratio satisfying the following equation

$${CsPb X}_{3} / ( {CsPb X}_{3} + {Cs}_{n - 1} {Pb}_{n} {X}_{3 n + 1}^{2 -} ) ,$$

wherein the molar ratio is in a range from 0 to about 1.00, from 0 to about 0.98, from 0 to about 0.92, from 0 to about 0.90, from 0 to about 0.85, from 0 to about 0.80, from 0 to about 0.75, from 0 to about 0.70, from 0 to about 0.60, from 0 to about 0.59, from 0 to about 0.50, from 0 to about 0.41, from 0 to about 0.40, from 0 to about 0.30, from 0 to about 0.20, from 0 to about 0.13, from 0 to about 0.10, or from about 0.10 to about 1.00, from about 0.13 to about 1.00, from about 0.20 to about 1.00, from about 0.30 to about 1.00, from about 0.40 to about 1.00, from about 0.41 to about 1.00, from about 0.50 to about 1.00, from about 0.59 to about 1.00, from about 0.60 to about 1.00, from about 0.70 to about 1.00, from about 0.75 to about 1.00, from about 0.80 to about 1.00, from about 0.85 to about 1.00, from about 0.90 to about 1.00, from about 0.92 to about 1.00, from about 0.98 to about 1.00, or about 0.10, about 0.13, about 0.20, about 0.30, about 0.40, about 0.41, about 0.50, about 0.59, about 0.60, about 0.70, about 0.75, about 0.80, about 0.85, about 0.90, about 0.92, about 0.98, or any value or range therein. It is to be appreciated that the above ranges should be interpreted as including and supporting any sub-ranges or discrete values (which may or may not be a whole number) that are within the stated range(s).

The particle may be dispersed in a solvent with a pH value in a range of from about 1 to about 7, from about 1 to about 6.5, from about 1 to about 6, from about 1 to about 5.5, from about 1 to about 5, from about 1 to about 4.5, from about 1 to about 4, from about 1 to about 3.5, from about 1 to about 3, from about 1 to about 2.5, from about 1 to about 2, from about 1 to about 1.5, from about 1 to about 1.2, or from about 1.2 to about 7, from about 1.5 to about 7, from about 2 to about 7, from about 2.5 to about 7, from about 3 to about 7, from about 3.5 to about 7, from about 4 to about 7, from about 4.5 to about 7, from about 5 to about 7, from about 5.5 to about 7, from about 6 to about 7, from about 6.5 to about 7, or about 1, about 1.2, about 1.5, about 2, about 2.5, about 3, about 3.5, about 4, about 4.5, about 5, about 5.5, about 6, about 6.5, about 7, or any value or range therein. It is to be appreciated that the above ranges should be interpreted as including and supporting any sub-ranges or discrete values (which may or may not be a whole number) that are within the stated range(s). The solvent may be a polar protic solvent. The solvent may be water.

The halide in CsPbX₃ and Csₙ₋₁PbX₃ₙ₊₁²⁻ may be the same halide. The halide may be Cl⁻, Br⁻, or I⁻ or a combination thereof. Advantageously, the selection of halides may allow the emission of the particle to be tuned from about 420 nm to about 670 nm, while maintaining high PLQY.

In an embodiment where X is Br⁻, the perovskite compound in the core may be CsPbBr₃, and the shell may comprise Csₙ₋₁PbₙBr₃ₙ₊₁²⁻ and an oleylammonium cation bilayer as the at least one organic ammonium cation R¹R²R³R⁴N⁺. As mentioned above, the value of n may be 1 or 2.

Exemplary, non-limiting embodiments of a method of passivating a perovskite compound will now be disclosed.

The method of passivating a perovskite compound CsPbX₃ comprises the step of adding an organic ammonium halide R¹R²R³R⁴NY to the CsPbX₃ at a molar ratio of R¹R²R³R⁴NY:CsPbX₃ of about 500:1 to about 60000:1 to form a mixture,

wherein
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X and Y are independently a halide.

Advantageously, the disclosed method may convert the 3D perovskite CsPbX₃ to a 0D perovskite at the disclosed ratios of the organic ammonium halide. This may allow the selective tuning of the 3D perovskite to achieve an optimal ratio of 3D perovskite to 0D perovskite. The method may also allow the formation of a particle having a core shell structure, where the particle is defined above. Still advantageously, the method may be carried out at low temperatures (such as at room temperature or between about 20° C. to about 25° C.), and at atmospheric pressure and conditions, without requiring high operating temperatures, air-free or inert atmospheres such as those used in conventional perovskite nanocrystal syntheses, for example, the “hot injection” method.

The organic ammonium cation and CsPbX₃ nanocrystals may be present in a molar ratio (Rₘ) in a range of from about 500 to about 60000, from about 500 to about 57471, from about 500 to about 50000, from about 500 to about 40000, from about 500 to about 30000, from about 500 to about 28736, from about 500 to about 25000, from about 500 to about 20000, from about 500 to about 15000, from about 500 to about 14000, from about 500 to about 13000, from about 500 to about 12000, from about 500 to about 11494, from about 500 to about 11000, from about 500 to about 10000, from about 500 to about 9000, from about 500 to about 8621, from about 500 to about 8000, from about 500 to about 7184, from about 500 to about 7000, from about 500 to about 6000, from about 500 to about 5747, from about 500 to about 5000, from about 500 to about 4000, from about 500 to about 3000, from about 500 to about 2874, from about 500 to about 2000, from about 500 to about 1149, from about 500 to about 1000, from about 500 to about 575, or from about 575 to about 60000, from about 1000 to about 60000, from about 1149 to about 60000, from about 2000 to about 60000, from about 2874 to about 60000, from about 3000 to about 60000, from about 4000 to about 60000, from about 5000 to about 60000, from about 5747 to about 60000, from about 6000 to about 60000, from about 7000 to about 60000, from about 7184 to about 60000, from about 8000 to about 60000, from about 8621 to about 60000, from about 9000 to about 60000, from about 10000 to about 60000, from about 11000 to about 60000, from about 11494 to about 60000, from about 12000 to about 60000, from about 13000 to about 60000, from about 14000 to about 60000, from about 15000 to about 60000, from about 20000 to about 60000, from about 25000 to about 60000, from about 28736 to about 60000, from about 30000 to about 60000, from about 40000 to about 60000, from about 50000 to about 60000, from about 57471 to about 60000, or about 500, about 575, about 1000, about 1149, about 2000, about 2874, about 3000, about 4000, about 5000, about 5747, about 6000, about 7000, about 7184, about 8000, about 8621, about 9000, about 10000, about 11000, about 11494, about 12000, about 13000, about 14000, about 15000, about 20000, about 2500, about 28736, about 30000, about 40000, about 50000, about 57471, about 60000, or any value or range therein. It is to be appreciated that the above ranges should be interpreted as including and supporting any sub-ranges or discrete values (which may or may not be a whole number) that are within the stated range(s).

The organic ammonium halide may be an oleylammonium halide, phenethylammonium halide, benzylammonium halide, or naphthylmethylammonium halide.

The halides X and Y may independently be Cl⁻, Br⁻, or I⁻. When X is Cl⁻, Rₘ may range from 500 to 60000, or from 500 to 57471. When X is Br⁻, Rₘ may range from 500 to 30000, or from 500 to 28736. When X is I⁻, Rₘ may range from 500 to 9000, or from 500 to 8621.

Advantageously, varying the halide Y may allow the tuning of the emission wavelength of the resultant particle. The emission wavelength of the particle may be in a range of from about 400 nm to about 700 nm, from about 400 nm to about 690 nm, from about 400 nm to about 680 nm, from about 400 nm to about 670 nm, from about 400 nm to about 660 nm, from about 400 nm to about 650 nm, from about 400 nm to about 640 nm, from about 400 nm to about 630 nm, from about 400 nm to about 620 nm, from about 400 nm to about 610 nm, from about 400 nm to about 600 nm, from about 400 nm to about 590 nm, from about 400 nm to about 580 nm, from about 400 nm to about 570 nm, from about 400 nm to about 560 nm, from about 400 nm to about 550 nm, from about 400 nm to about 540 nm, from about 400 nm to about 530 nm, from about 400 nm to about 520 nm, from about 400 nm to about 518 nm, from about 400 nm to about 510 nm, from about 400 nm to about 505 nm, from about 400 nm to about 500 nm, from about 400 nm to about 490 nm, from about 400 nm to about 480 nm, from about 400 nm to about 470 nm, from about 400 nm to about 460 nm, from about 400 nm to about 450 nm, from about 400 nm to about 440 nm, from about 400 nm to about 430 nm, from about 400 nm to about 420 nm, from about 400 nm to about 410 nm, from about 400 nm to about 404 nm, or from about 404 nm to about 700 nm, from about 410 nm to about 700 nm, from about 420 nm to about 700 nm, from about 430 nm to about 700 nm, from about 440 nm to about 700 nm, from about 450 nm to about 700 nm, from about 460 nm to about 700 nm, from about 470 nm to about 700 nm, from about 480 nm to about 700 nm, from about 490 nm to about 700 nm, from about 500 nm to about 700 nm, from about 505 nm to about 700 nm, from about 510 nm to about 700 nm, from about 518 nm to about 700 nm, from about 520 nm to about 700 nm, from about 530 nm to about 700 nm, from about 540 nm to about 700 nm, from about 550 nm to about 700 nm, from about 560 nm to about 700 nm, from about 570 nm to about 700 nm, from about 580 nm to about 700 nm, from about 590 nm to about 700 nm, from about 600 nm to about 700 nm, from about 610 nm to about 700 nm, from about 620 nm to about 700 nm, from about 630 nm to about 700 nm, from about 640 nm to about 700 nm, from about 650 nm to about 700 nm, from about 660 nm to about 700 nm, from about 670 nm to about 700 nm, from about 680 nm to about 700 nm, from about 690 nm to about 700 nm, or about 400 nm, about 404 nm, about 410 nm, about 420 nm, about 430 nm, about 440 nm, about 450 nm, about 460 nm, about 470 nm, about 480 nm, about 490 nm, about 500 nm, about 505 nm, about 510 nm, about 518 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, or any value or range therein. It is to be appreciated that the above ranges should be interpreted as including and supporting any sub-ranges or discrete values (which may or may not be a whole number) that are within the stated range(s).

Where Y is Cl⁻, the emission wavelength may be in a range of from about 395 nm to about 430 nm, from about 395 nm to about 425 nm, from about 395 nm to about 420 nm, from about 395 nm to about 415 nm, from about 395 nm to about 410 nm, from about 395 nm to about 405 nm, from about 395 nm to about 400 nm, or from about 400 nm to about 430 nm, from about 405 nm to about 430 nm, from about 410 nm to about 430 nm, from about 415 nm to about 430 nm, from about 420 nm to about 430 nm, from about 425 nm to about 430 nm, or about 395 nm, about 400 nm, about 405 nm, about 410 nm, about 415 nm, about 420 nm, about 425 nm, about 430 nm, or any value or range therein. It is to be appreciated that the above ranges should be interpreted as including and supporting any sub-ranges or discrete values (which may or may not be a whole number) that are within the stated range(s).

Where Y is Br⁻, the emission wavelength may be in a range of from about 505 nm to about 535 nm, from about 505 nm to about 530 nm, from about 505 nm to about 525 nm, from about 505 nm to about 520 nm, from about 505 nm to about 515 nm, from about 505 nm to about 510 nm, or from about 510 nm to about 535 nm, from about 515 nm to about 535 nm, from about 520 nm to about 535 nm, from about 525 nm to about 535 nm, from about 530 nm to about 535 nm, or about 505 nm, about 510 nm, about 515 nm, about 520 nm, about 525 nm, about 530 nm, about 535 nm, or any value or range therein. It is to be appreciated that the above ranges should be interpreted as including and supporting any sub-ranges or discrete values (which may or may not be a whole number) that are within the stated range(s).

Where Y is I⁻, the emission wavelength may be in a range of from about 630 nm to about 710 nm, from about 630 nm to about 700 nm, from about 630 nm to about 690 nm, from about 630 nm to about 680 nm, from about 630 nm to about 670 nm, from about 630 nm to about 660 nm, from about 630 nm to about 650 nm, from about 630 nm to about 640 nm, or from about 640 nm to about 710 nm, from about 650 nm to about 710 nm, from about 660 nm to about 710 nm, from about 670 nm to about 710 nm, from about 680 nm to about 710 nm, from about 690 nm to about 710 nm, from about 700 nm to about 710 nm, or about 630 nm, about 640 nm, about 650 nm, about 660 nm, about 670 nm, about 680 nm, about 690 nm, about 700 nm, about 710 nm, or any value or range therein. It is to be appreciated that the above ranges should be interpreted as including and supporting any sub-ranges or discrete values (which may or may not be a whole number) that are within the stated range(s).

The method may further comprise, before the adding step a), the step of:

a1) providing the perovskite compound CsPbX₃.

The providing step a1) may further comprise the step of:

a2) selecting the perovskite compound CsPbX₃ having a size in a range of from about 10 nm to about 20 nm, from about 10 nm to about 19 nm, from about 10 nm to about 18 nm, from about 10 nm to about 17 nm, from about 10 nm to about 16 nm, from about 10 nm to about 15 nm, from about 10 nm to about 14 nm, from about 10 nm to about 13 nm, from about 10 nm to about 12 nm, from about 10 nm to about 11 nm, or from about 11 nm to about 20 nm, from about 12 nm to about 20 nm, from about 13 nm to about 20 nm, from about 14 nm to about 20 nm, from about 15 nm to about 20 nm, from about 16 nm to about 20 nm, from about 17 nm to about 20 nm, from about 18 nm to about 20 nm, from about 19 nm to about 20 nm, or about 10 nm, about 11 nm, about 12 nm, about 13 nm, about 14 nm, about 15 nm, about 16 nm, about 17 nm, about 18 nm, about 19 nm, about 20 nm, or any value or range therein. It is to be appreciated that the above ranges should be interpreted as including and supporting any sub-ranges or discrete values (which may or may not be a whole number) that are within the stated range(s).

When the perovskite compound has a size in the disclosed range, it may advantageously allow the adjustment of the multiexciton recombination process, which may advantageously allow the single photon emission or stimulated emission properties of the particle to be carefully and selectively tuned.

The method may further comprise the step of:

b) stirring the mixture for about 2 hours.

Step b) may be carried out at room temperature, or between about 20° C. to about 25° C.

The method may further comprise the step of:

c) adding at least one solvent, and centrifuging the resulting mixture to obtain a precipitate.

The method may further comprise the step of:

d) dispersing the passivated perovskite compound in a polar protic solvent. The solvent may be water.

The method of passivating the perovskite compound CsPbX₃ may also be deemed as a method of forming a particle having a core-shell structure, where the particle is as defined above. Hence, the method of forming a particle having a core-shell structure comprises the step of adding an organic ammonium halide R¹R²R³R⁴NY to a perovskite compound CsPbX₃ at a molar ratio of R¹R²R³R⁴NY:CsPbX₃ of about 500:1 to about 60000:1 to form a mixture,
wherein
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X and Y are independently a halide.

Provided herein is also a particle produced by the method as disclosed herein. The particle is as defined above. Thus, there is provided a particle having a core shell structure produced by the method as defined herein, wherein the core comprises a perovskite compound CsPbX₃, and the shell comprises Csₙ₋₁PbₙX₃ₙ₊₁²⁻ and at least one organic ammonium cation R¹R²R³R⁴N⁺,
wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X is a halide.

Exemplary, non-limiting embodiments of a use of the particle will now be disclosed.

The use of the particle as disclosed herein may be in full colour displays, lasers, bioimaging labels, spintronic devices, or quantum light emitters.

### EXAMPLES

Non-limiting examples of the invention and comparative examples will be further described in greater detail by reference to specific examples, which should not be construed as in any way limiting the scope of the invention.

### Material and Methods

Lead bromide (99.999%), cesium bromide (99.999%), oleylamine (70%), oleic acid (90%), ethyl acetate (anhydrous, 99.8%), hexane (anhydrous, 95%), toluene (anhydrous, 99.8%), N,N-dimethylformamide (anhydrous, 99.8%), dimethyl sulfoxide (anhydrous, ≥99.9%), were purchased from Sigma-Aldrich (St. Louis, Missouri, USA). OAmX (≥99%, X═Cl, Br, I) were purchased from Xi'an Yuri Solar Co., Ltd (Xi'an, China). Reagents were used as such without further purification.

### Preparation of the Template CsPbBr₃ Nanocrystals

CsPbBr₃ nanocrystals (NCs) were synthesized by the ligand-assisted re-precipitation (LARP) method. Briefly, PbBr₂ (73.4 mg, 0.2 mmol), CsBr (34.1 mg, 0.16 mmol), oleic acid (OAc, 0.5 mL), and oleylamine (OAm, 0.25 mL) were added to 5 mL DMF/DMSO mixed solution with a volume ratio of 9:1 and stirred at 60° C. for 1 hour to be fully dissolved to form the precursor solution. A portion (1 mL) of the obtained precursor solution was swiftly injected into 10 mL toluene under vigorous stirring. After stirring, the resultant solution was then subjected to a combination of centrifugation, i.e., removal of small-sized crystals at high speed (e.g., 8,000 rpm for 5 minutes), and removal of large-sized crystals at low speed (e.g., 3,000 rpm for 5 minutes). The final size-sieved nanocrystals (˜17 nm) were stored in 12 mL n-hexane for further use. Specifically, to be used for solution-phase single-photon emission measurement, perovskite nanocrystals with a smaller average size (˜14 nm) were prepared. In detail, the preparation time of the precursor solution was shortened from 1 hour to 30 minutes. The centrifugation process was modified to 14,000 rpm (5 minutes) for removal of small sized crystals and 10,000 rpm (5 minutes) for removal of large sized crystals. The final size-sieved nanocrystals (˜14 nm) were then stored in 6 mL n-hexane for further use. The other steps remained consistent with the aforementioned description.

### Preparation of Oleylammonium Halide Solution

0.5 mmol oleylammonium halide salts were added to 5 mL toluene and stirred to be fully dissolved for further use.

Post-Treatment of the Template CsPbBr₃ Nanocrystals with OAmX

5-1000 μL oleylammonium halide solution was added to 5 mL template CsPbBr₃ nanocrystals solution (after 0.2 μm PTFE filtration, ˜348 nM, average size of ˜17 nm) and stirred for 2 hours at room temperature (e.g. the sample named Br-5747 obtained using 100 μL OAmBr solution (80 μL for ˜14 nm template samples) for post-treatment of 5 mL template CsPbBr₃ nanocrystals solution). Then the resultant solution was mixed with toluene and ethyl acetate at a volume ratio of 1:1:2 and centrifuged (6000 rpm for 2 min) for obtaining the precipitate. Finally, after vacuum drying, the precipitate was directly dispersed in 4 mL hexane or distilled water for subsequent measurements. Specifically, for solution-phase single-photon emission measurement, the precipitate was dispersed in 2 mL distilled water as the initial aqueous HPNCs solution for the following dilution.

### Structural Characterization

Fourier Transform Infrared (FTIR) spectra were taken in attenuated total reflection mode (ATR) using a commercial FTIR spectrometer (from Bruker Invennio-R) equipped with diamond ATR accessory. The setup was constantly purged with dry N₂ gas. Powder X-ray diffraction (PXRD) patterns were measured using a PANalytical X'Pert Pro X-ray diffraction system (from PANalytical Inc.) with monochromatic Cu Kα irradiation (λ=1.5418 Å). Zeta potentials of aqueous HPNCs were characterized by Zetadizer3000HSA.

### Transmission Electron Microscopy (TEM) Measurements

The general TEM images were collected in a JEOL JEM 1400 TEM. The HR-TEM images were recorded in a JEOL ARM300 TEM equipped of a probe and an image corrector. For in-situ liquid cell TEM: A K-Kit liquid cell (K-Kit from Bio MA-TEK) was employed to observe the structure of the specimen and kept in an aqueous solution. The prepared solution was loaded into the K-Kit microchip, which was then sealed with water-resistant glue. The window size of the liquid cell microchip was 300 m×25 μm. Up and bottom SiN membranes have a thickness of 30 nm seal liquid, which allow for electron transparency for in-situ observation. The assembled microchip containing the specimen was placed into the TEM holder for further observation. In-situ liquid environment TEM images were collected by a FEI Titan G² 60-300 spherical aberration-corrected TEM.

### Optical Measurements

For femtosecond transient absorption (TA) experiments, they were performed using a Phasetech spectrometer (from PhaseTech Spectroscopy, Inc.). The 400 nm pump pulse was generated by second harmonic generation (SHG) from a 1 kHz regenerative amplifier (Coherent Astrella, 35 fs, 1 kHz, 800 nm), with 3.5 mJ input pulse energy. The system was seeded by a mode-locked Ti-sapphire oscillator (Coherent Vitesse, 80 MHz). The white light continuum probe beam was generated by focusing a small portion (˜10 μJ) of the regenerative amplifier's fundamental 800 nm laser pulses into a 2 mm sapphire crystal (for visible range). The probe beam was collected using a CCD sensor (Teledyne e2v). TRPL measurements were performed by a fluorescence lifetime system with a pulse laser with 40 MHz ((LDH-P-C-405B, Pico Quant), a single photon detector (PD-100-CTD-FC, MPD, Pico Quant) and the tine-tagged time-resolved (TTTR) module (Pico-Harp 300, Pico Quant). Steady-state absorption spectra were collected using a Shimadzu UV-3600 UV-VIS-NIR spectrophotometer. PLQY and CIE measurements were performed using a Horiba Jobin-Yvon Fluorolog system equipped with iHR320 monochromator, coupled with a photomultiplier tube and a spectrally calibrated Spectralon-coated integrating sphere (Quanta-Phi). Excitation energy was varied by selecting different components of a Xe lamp emission with a monochromator. Sample solutions were contained in a 2 mm quartz cuvette.

### Solution Phase Photon Correlation Experimental Setup

The study was performed using a modified Nikon Eclipse Ti inverted confocal microscope. The setup comprises an excitation laser, confocal microscope, and measurement devices. A picosecond laser was used for excitation. The PL signal from the solution sample was collected by a 100× oil immersion lens and then passed through a dichroic mirror. A long-pass filter was used to remove the pump signal, and the PL signal was then collected by a multimode fibre and analysed using a spectrometer and a Hanbury Brown and Twiss (HBT) setup.

### Example 1: Structural Transformation of 3D Perovskites to 0D Perovskites

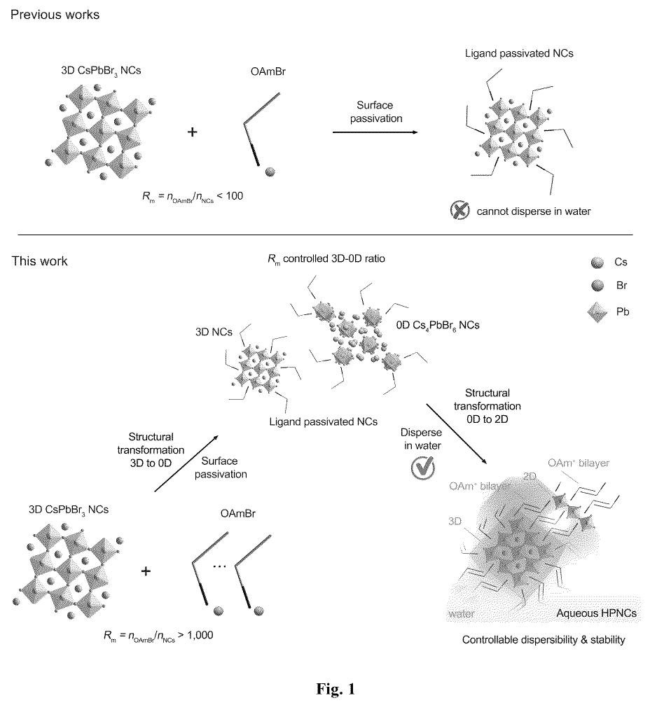

Pristine 3D CsPbBr₃ nanocrystals (NCs) were synthesized via a facile ligand-assisted re-precipitation (LARP) method and were subsequently treated with OAmBr according to the protocol above and as shown in FIG. 1 “This work”.

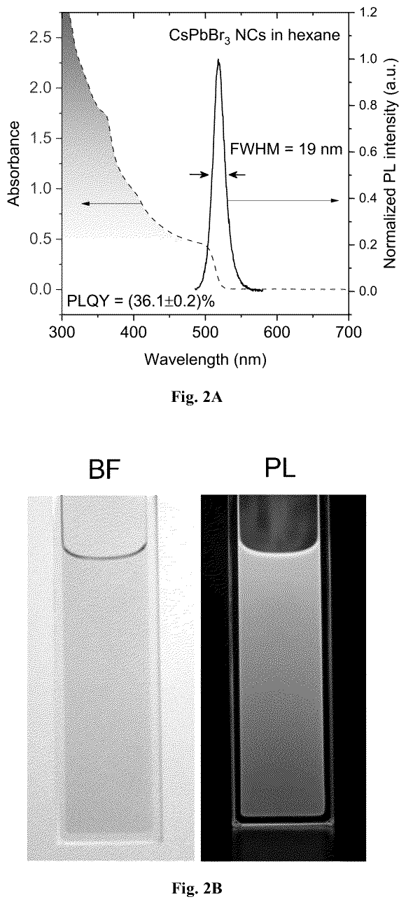

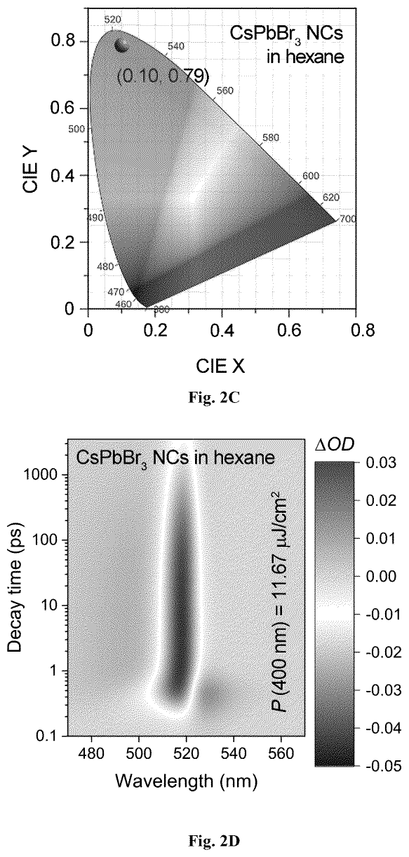

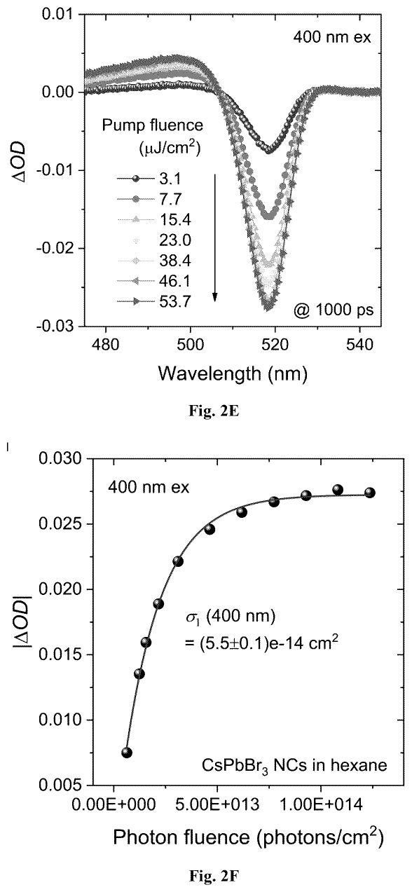

The optical characterization of the synthesized nanocrystals is shown in FIG. 2A to FIG. 2F, with FIG. 2A showing the absorption and photoluminescence (PL) spectra of CsPbBr₃ NCs. FIG. 2B shows images of CsPbBr₃ NCs in hexane under bright field (BF) and PL upon 365 nm excitation, and FIG. 2C shows a CIE spectrum of as-synthesized CsPbBr₃ NCs in hexane. FIG. 2D is a pseudo-colour TA plot of CsPbBr₃ NCs in hexane, and FIG. 2E shows a pump fluence dependent TA spectra in the region of bleaching signal at the delay time of 1000 ps, with excitation wavelength at 400 nm. FIG. 2F shows |DOD| as the function of photon fluence for 400 nm excitation at the delay time of 1000 ps.

The linear absorption cross-section (s₁) is determined by the transient absorption (TA) saturation method. By analysing the bleaching signal |ΔOD|ₜ_{ₗ} at the exciton absorption peak in the TA data of the optically diluted sample at a sufficiently long pump-probe delay time (tₗ), the Poisson distribution is used to describe the related dynamic processes generated after excitation:

$${\vert Δ OD \vert}_{{t}_{1}} = a ( 1 - {e}^{- 〈 N 〉} ) ; 〈 N 〉 = {σ}_{1} F = {σ}_{1} \frac{{P}_{peak}}{ℏ ω} τ \qquad Equation ( 1 )$$

in which, a is a constant that related to instrumental and sample parameters. [symbol] N [symbol] refers to the average number of photons absorbed per QD at the given excitation fluence. σ₁ refers to the linear absorption cross-section (in cm²), and F refers to the photon fluence (in cm⁻² photons) at the given excitation wavelength. Besides, Pₚₑₐₖ is the peak power density, ℏω is the photon energy for excitation and τ is the laser pulse width (˜100 fs in our experiments). By plotting F and |ΔOD|ₜ_{ₗ} and fitting the data using Equation 1, the value of σ₁ can be derived.

The solid curve (FIG. 2F) is the best fit to Equation 1, which can be used to estimate the absorption cross-section (s₁) of as-synthesized CsPbBr₃ NCs in hexane to be ˜5.5′10⁻¹⁴ cm². According to Beer-Lambert law:

$$A = \frac{{N}_{A}}{ln 10} {σ}_{1} lc ,$$

where absorbance (A) of as-synthesized CsPbBr₃ NCs in hexane at 400 nm is ˜1.0 (FIG. 2A), and the thickness (l) of cuvette is 2 mm. Therefore, the concentration (c) of as-synthesized CsPbBr₃ NCs in hexane is calculated to be ˜348 nM.

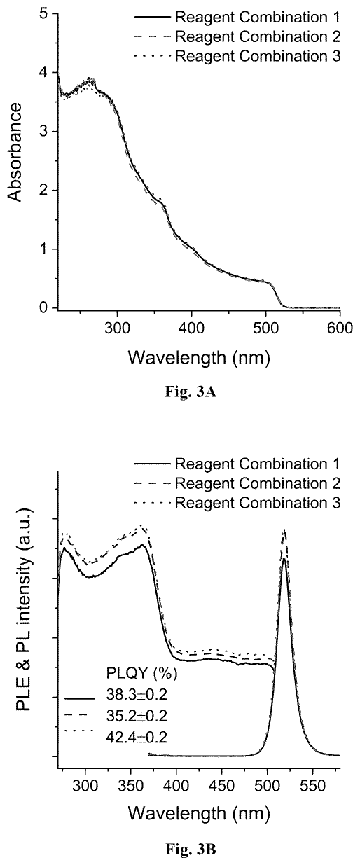

FIG. 3A and FIG. 3B show the reproducibility of LARP synthesis of the pristine CsPbBR₃ NCs, with FIG. 3A showing the absorbance of CsPbBr₃ NCs obtained by three reagent combinations, and FIG. 3B showing the photoluminescence excitation (PLE) and PL spectra of CsPbBr₃ NCs obtained by three reagent combinations. These results show good synthesis reproducibility. A summary of the reagent combinations is seen in Table 1.

TABLE 1
Reagent details for synthesis.
Step 1 - LARP synthesis

| Reagent | | | | | | |
|---|---|---|---|---|---|---|
| Combination | | | | | Solvents for | |
| No. | Pb source | Cs source | Ligands | | dissolving precursors | Anti-solvent |
| RC-1 | PbBr₂ | CsBr | OAc | OAm | DMF (99.8%, Sigma- | Toluene |
| | (99.999%, | (99.999%, | (90%, | (70%, | Aldrich) + DMSO | (99.8%, |
| | Sigma- | Sigma- | Sigma- | Sigma- | (99.9%, Sigma- | Sigma- |
| | Aldrich) | Aldrich) | Aldrich) | Aldrich) | Aldrich) | Aldrich) |
| RC-2 | PbBr₂ | CsBr (99%, | OAc | OAm | DMF (99.8%, Extra | Toluene |
| | (homemade) | Alfa Aesar) | (90%, | (70%, | Dry, Thermo | (99.85%, |
| | | | Sigma- | Sigma- | Scientific) + DMSO | Extra Dry, |
| | | | Aldrich) | Aldrich) | (99.7+%, Extra Dry, | Thermo |
| | | | | | Thermo Scientific) | Scientific) |
| RC-3 | PbBr₂ | CsBr | OAc | OAm | DMF (99.8%, Extra | Toluene |
| | (homemade) | (granular, | (distilled) | (distilled) | Dry, Thermo | (99.85%, |
| | | Chem Craft) | | | Scientific) + DMSO | Extra Dry, |
| | | | | | (99.7+%, Extra Dry, | Thermo |
| | | | | | Thermo Scientific) | Scientific) |

Step 2 - OAmBr treatment & water dispersion

| | | | Solvent for | |
|---|---|---|---|---|
| No. | Pristine CsPbBr₃ NCs | OAmBr source | dissolving OAmBr | water |
| Batch 1-3* | From RC-1, in solvent | OAmBr (≥99%, | Toluene (99.8%, | Distilled water |
| | hexane (95%, Sigma- | Xi'an Yuri Solar | Sigma-Aldrich) | |
| | Aldrich) | Co., Ltd) | | |

OAmBr treatment amount

| | Actual adding amount (μL) to the 5 mL template |
|---|---|
| | CsPbBr₃ NCs solution (after 0.2 μm PTFE filtration, |
| Rm (n_{OAmBr/ntemplate-NCs}) | ~348 nM, average size of ~17 nm) |
| 287.4 | 5 |
| 574.7 | 10 |
| 1,149 | 20 |
| 2,874 | 50 |
| 5,747 | 100 |
| 11,494 | 200 |
| 28,736 | 500 |

RC: reagent combination.
*Three batches were conducted independently.

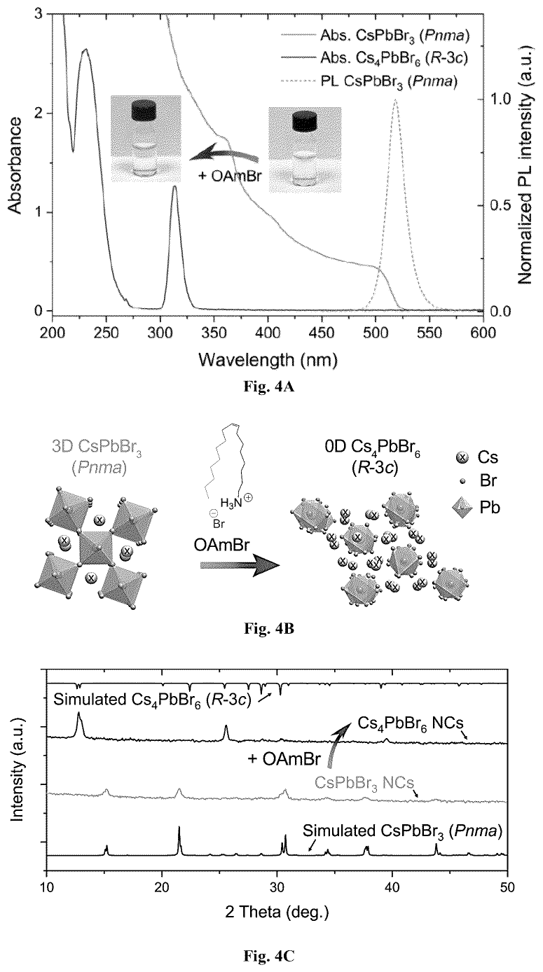

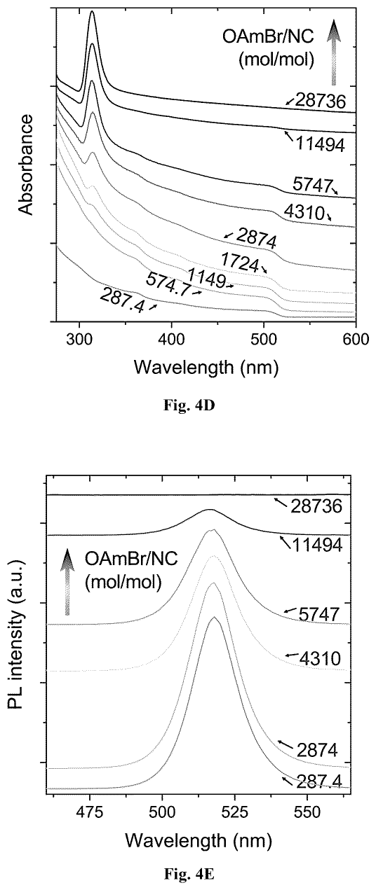

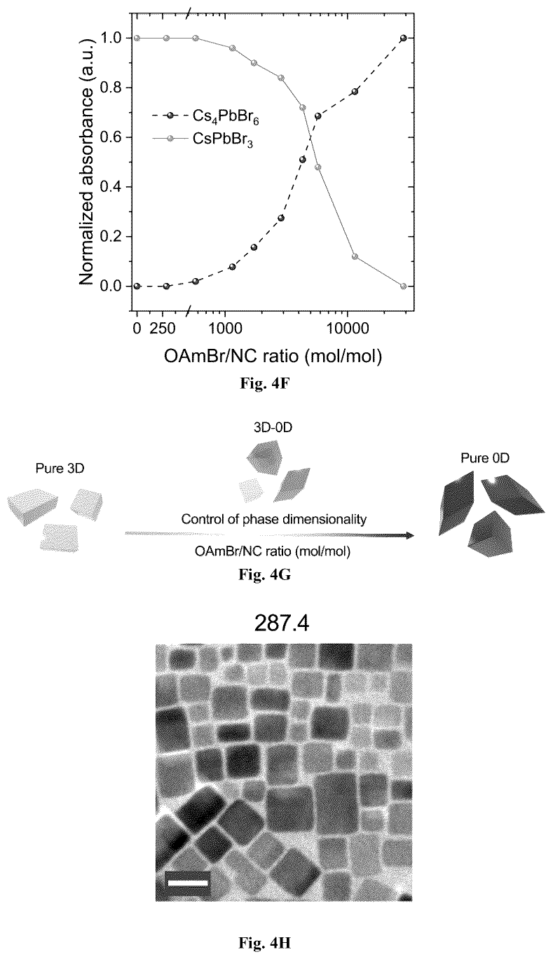

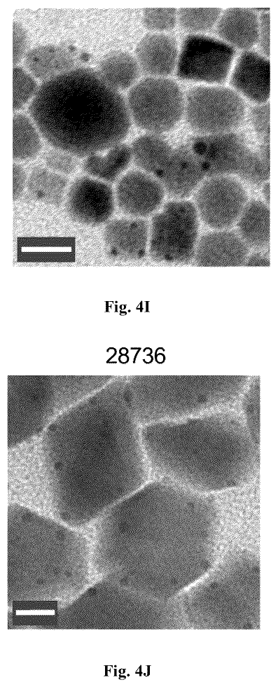

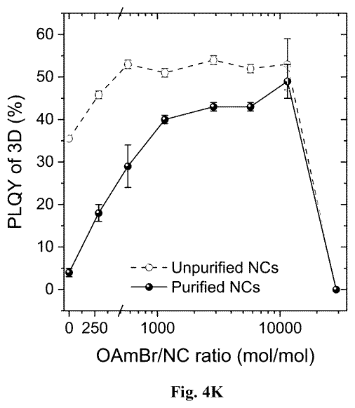

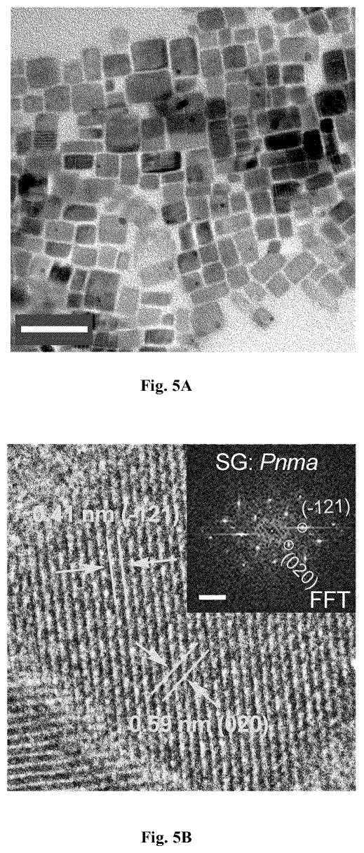

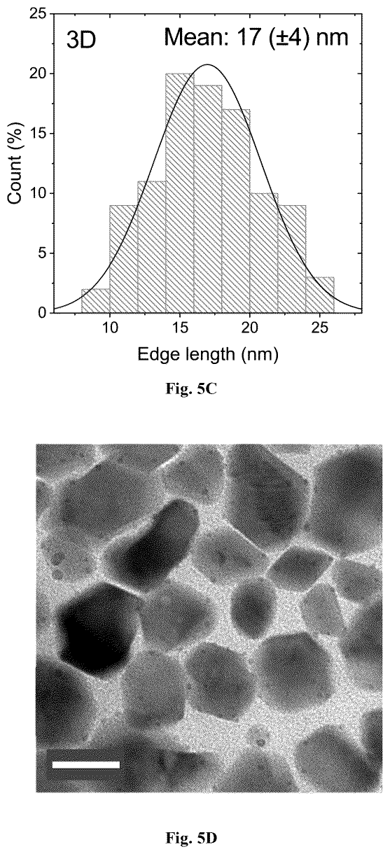

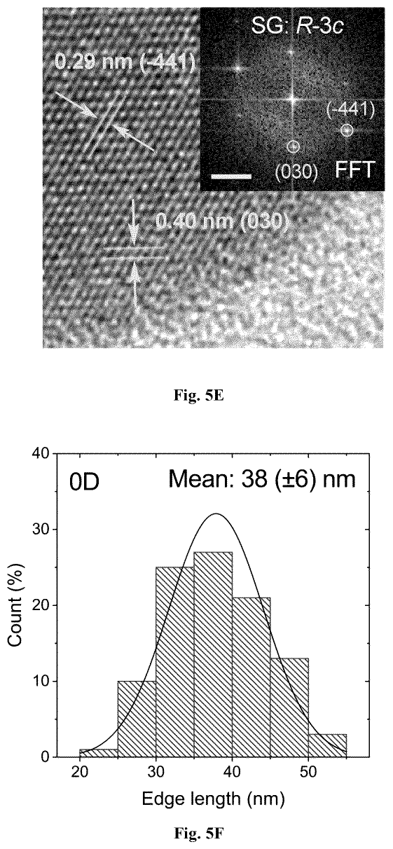

Typically, OAmBr serves as a surface passivation ligand for halide perovskite nanocrystals (HPNCs) at treatment molar ratio below 100. (FIG. 1, “Previous works”) However, using a significantly higher treatment amount (Rₘ˜29,000) enables a complete structural transformation of 3D CsPbBr₃ NCs to 0D Cs₄PbBr₆ NCs under ambient conditions at room temperature (FIG. 1, “This work”) which is unexpected and a departure from the current state of the art which uses a smaller molar ratio instead of a higher molar ratio as shown in this application. This transformation is visually captured in FIG. 4A and FIG. 4B, which show both the optical spectra and a schematic representation of the process. The 3D phase exhibited an absorption onset at ˜504 nm with Stokes-shifted photoluminescence (PL) at 518 nm and a yellow-green colour solution. As it was converted to the 0D phase, a distinct shift to a sharp absorption peak at 314 nm was observed without PL emission (colourless solution—FIG. 4A). Structural analysis confirmed this transformation, with powder X-ray diffraction (PXRD) patterns matching the orthorhombic CsPbBr₃ Pnma phase and the trigonal Cs₄PbBr₆ R-3c phase for the pristine and transformed NCs, respectively (FIG. 4C). Transmission electron microscopy (TEM) images revealed a shift from cuboidal CsPbBr₃ NCs (average edge length of 17 (±4) nm) to polygonal shapes after transformation (FIGS. 5A to 5D). High-resolution TEM (HRTEM) further identified the lattice spacings of 0.29 nm and 0.40 nm (derived from the fast Fourier transform (FFT) pattern), consistent with the (−441) and (030) planes of R-3c Cs₄PbBr₆ (FIG. 5E). The average edge length of the transformed 0D Cs₄PbBr₆ NCs was calculated to be 38 (±6) nm (FIG. 5F).

Next, the thermodynamic boundary of this transformation was scrutinized, the findings indicated that the shift from 3D CsPbBr₃ NCs to 0D Cs₄PbBr₆ NCs was initiated at Rₘ˜1,000 and reached full conversion at Rₘ˜30,000. As the OAmBr treatment amount increased, the spectral indicators shifted accordingly (FIGS. 4D to 4F): the 3D-phase absorption and emission weakened while the OD-phase phase absorption strengthened, reflecting a decomposition of the 3D phase and a corresponding formation of the OD structure. Morphologically (FIGS. 4G to 4J), NCs transitioned from a 3D cuboidal shape at low Rₘ values to a polyhedral shape (with a dominant rhombohedral morphology, characteristic of the 0D phase) at higher Rₘ, with mixed morphologies including 3D-0D core-shell structures at intermediate stages, suggesting a progressive restructuring toward the 0D phase. This transformation process mediated by OAmBr is outlined as follows:

$$4 {CsPbBr}_{3} + 6 OAmBr \to {Cs}_{4} {PbBr}_{6} + 3 {( OAmBr )}_{2} [ {PbBr}_{2} ] \qquad ( 2 )$$

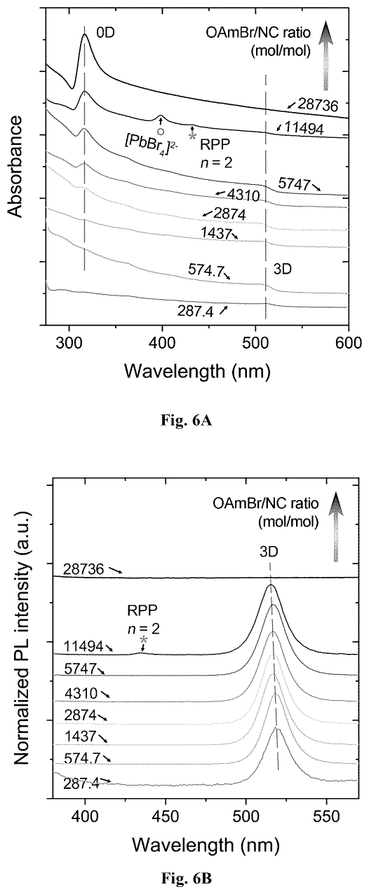

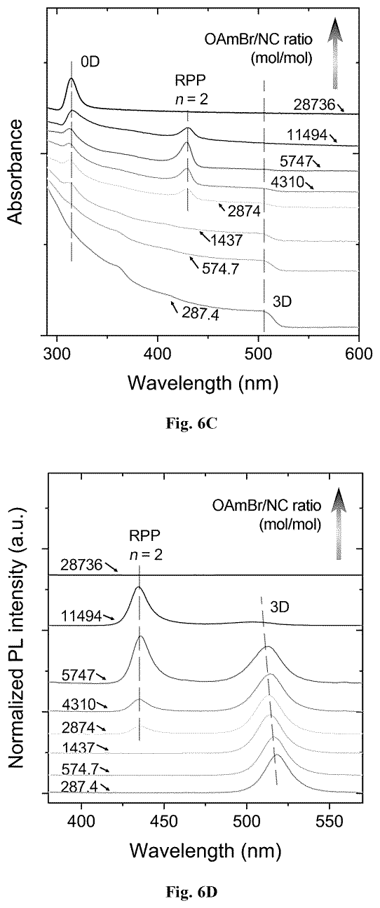

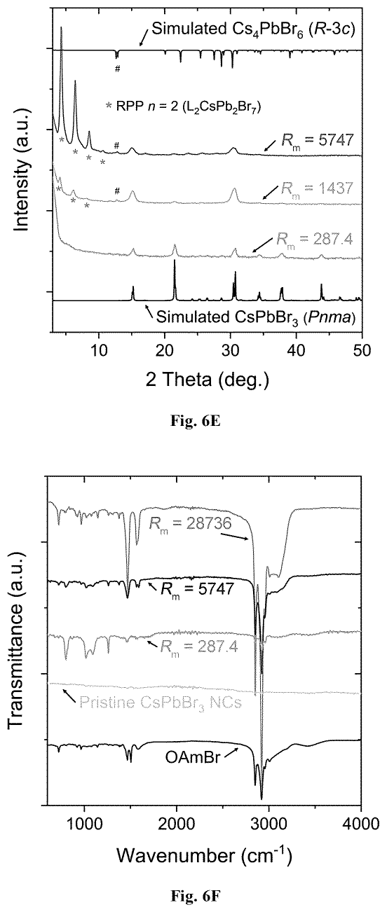

Interestingly, this transformation appeared to encourage the emergence of additional species under purification process (i.e., introduction of toluene and ethyl acetate, centrifugation, removal of supernatant and redispersion of the precipitate in hexane), including Ruddlesden-Popper perovskite (RPP) L₂Csₙ₋₁PbₙBr₃ₙ₊₁, where L is the protonated oleylamine (OAm⁺) and n is the number of Pb—Br octahedral monolayers (FIGS. 6A to 6F).

After the structural conversion and purification process, the formation of new species is observed.

Absorption and PL spectra of the supernatants after purification process (FIGS. 6C and 6D) clearly show that the absorption peak at ˜428 nm with emission at ˜435 nm becoming more pronounced as the Rₘ increases. Considering the chemical composition in the solution, these characteristic peak positions correspond to the structure of the n=2 Ruddlesden-Popper perovskite (RPP) L₂Csₙ₋₁PbₙBr₃ₙ₊₁ where L is generally a hydrocarbon chain cation, which should be oleylammonium (OAm⁺) here and n is the number of Pb—Br octahedral monolayers. This RPP structure is also evident as periodic peaks at small angles (2θ<10°) in the PXRD pattern and starts from Rₘ>1,000, similar to the conditions for the onset of 0D phase formation (FIG. 6E). In addition, under higher amount of OAmBr treatment (Rₘ˜11,494), the precipitate also shows an absorption peak at ˜397 nm, but no corresponding Stokes-shifted PL emission (FIGS. 6A and 6B). Hence this absorption peak should be from the [PbBr₄]²⁻ based amorphous species that has yet to form the n=1 RPP. However, as the treatment amount increased to full conversion (Rₘ˜28,736), absorption and emission characteristics attributed to these new species disappear (FIGS. 6A to 6D), indicating that a large amount of OAmBr tends to isolate the [PbBr₆]⁴⁻ structure, fully forming the 0D phase.

Moreover, OAmBr consistently aided in surface passivation, initially increasing the PLQY by nearly 20% (FIG. 4K), though some PLQY reduction post-purification hinted at unavoidable ligand desorption. After the purification process, two species [PbBr₄]²⁻ and RPP n=2, L₂CsPb₂Br₇ (L=OAm⁺) were newly generated, and the related proposed reactions are:

$${{( OAmBr )}_{2} [ PbBr ]}_{4} + {CsPbBr}_{3} \to {( OAm )}_{2} {CsPb}_{2} {Br}_{7} ( RPP , n = 2 ) ; \qquad ( i )$$

$${( OAmBr )}_{2} [ {PbBr}_{2} ] + {( OAm )}_{2} \to {( OAm )}_{2} [ {PbBr}_{4} ] ( amorphous ) . \qquad ( ii )$$

In addition, FTIR spectra indicated that even after purification, the precipitate of OAmBr-treated samples still contained OAmBr; and the larger the treatment amount, the higher the content was. Thus, OAmBr remained associated with the NC surface (FIG. 6F), playing a further role in the subsequent water induced structural evolution.

### Example 2: Water Stability and Dispersibility of Perovskite Nanocrystals

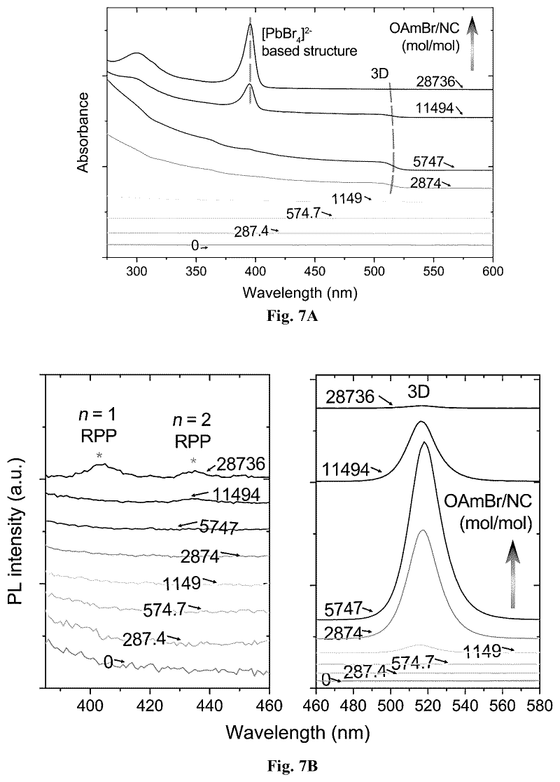

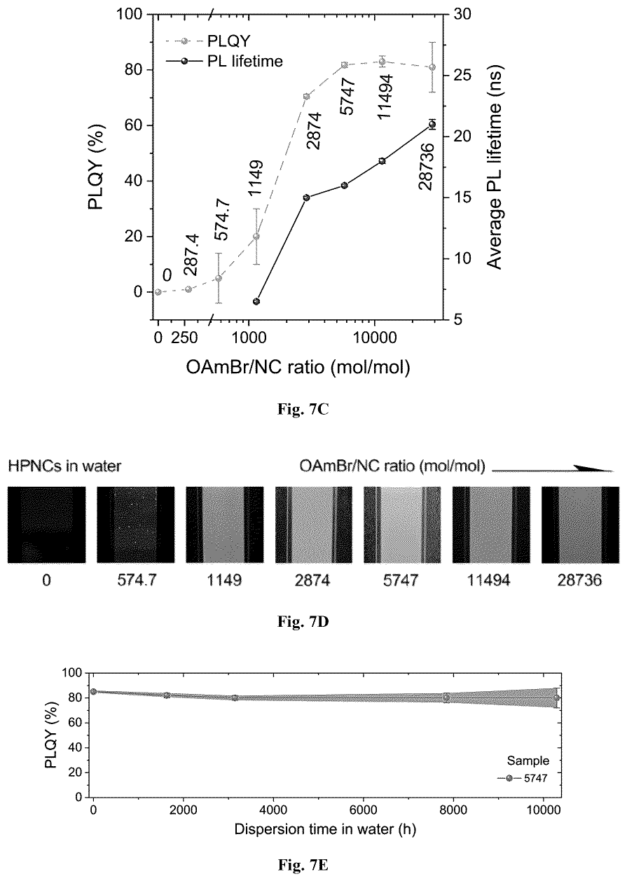

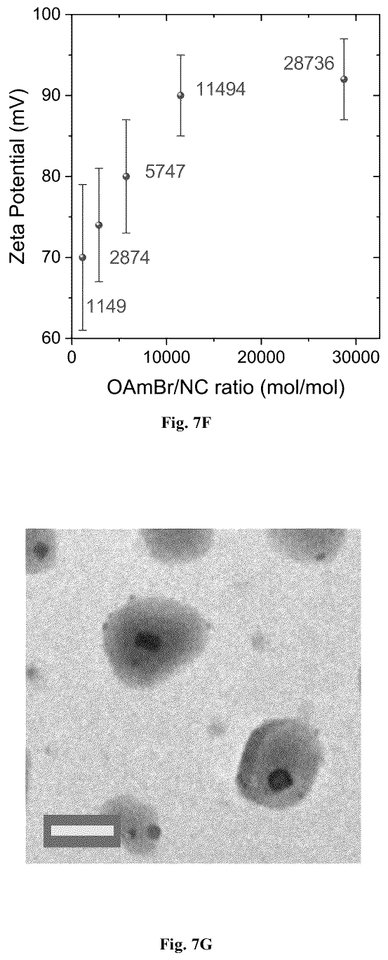

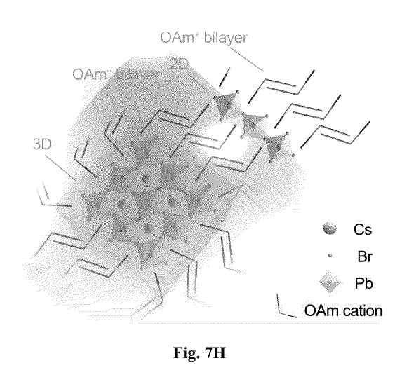

In this example, it is demonstrated that post-treated HPNCs, modified with different ratios of OAmBr, can be dispersed in water to achieve tunable optical properties, stability, and dispersibility. Under low OAmBr treatment (Rₘ<500), the HPNCs lost their 3D-phase characteristics, showing negligible PLQY in water (FIGS. 7A and 7B). In contrast, at higher treatment levels (Rₘ>2,800), the 3D phase was greatly preserved, exhibiting robust green emission in water with a PLQY of ≥70% and an average PL lifetime of ≥15 ns (FIGS. 7B to 7D).

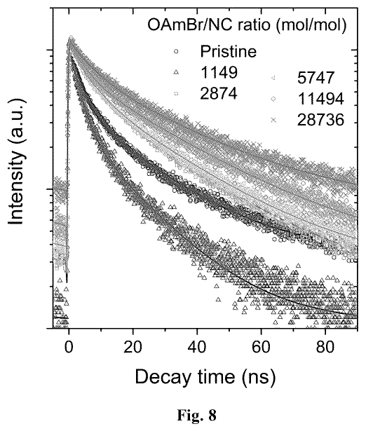

The pristine CsPbBr₃ NCs possess an average PL lifetime of approximately 9.5 ns, with a PLQY of around 36.1% (FIG. 2A). Upon investigating the ultimate aqueous HPNCs products, it shows that when the amount of OAmBr treatment is low (e.g., Rₘ≈1,149), the average PL lifetime of the sample decreased to ˜6.5 ns (FIG. 8, Table 2), corresponding to a PLQY of around 20%, indicating a lack of effective passivation protection on the luminescent 3D NC surface, with significant defects present. In contrast, when the treatment amount was increased to Rₘ≥2.874, the resultant aqueous HPNCs exhibited a significantly improved average lifetime of over 15 ns (FIG. 8, Table 2), and the PLQYs increased dramatically to over 70%, far exceeding the luminescence performance of the pristine NCs in the organic phase. This indicates that even in a water environment, the luminescent 3D phase in the samples remains well-passivated, suppressing non-radiative transitions caused by surface defects.

Table 2 shows the fitting parameters of TRPL decays for representative samples with different amount of OAmBr treatment, using the pristine CsPbBr₃ NCs in hexane (without treatment) for comparison. Excitation: 1 MHz 475 nm pulse laser with pulse width<70 ps, pump fluence ˜0.1 W/cm². τ_{avg}=ΣAᵢτᵢ/ΣAᵢ.

TABLE 2
Fitting parameters of TRPL decays for representative
samples with different amount of OAmBr treatment.

| Treatment amount | PL lifetime fitting parameters | | | | |
|---|---|---|---|---|---|
| (Rₘ) of OAmBr | A₁ | τ₁ (ns) | A₂ | τ₂ (ns) | τ_{avg} (ns) |
| Pristine (in hexane) | 1.14 ± 0.02 | 21 ± 0.4 | 2.22 ± 0.03 | 3.3 ± 0.1 | 9.5 ± 0.1 |
| 1149 | 0.287 ± 0.005 | 16.8 ± 0.02 | 0.87 ± 0.01 | 3.11 ± 0.04 | 6.5 ± 0.1 |
| 2874 | 1.64 ± 0.03 | 25 ± 0.3 | 1.78 ± 0.02 | 6.1 ± 0.2 | 15 ± 0.1 |
| 5747 | 1.61 ± 0.02 | 26 ± 0.2 | 1.58 ± 0.02 | 5.8 ± 0.1 | 16 ± 0.1 |
| 11494 | 0.75 ± 0.01 | 29 ± 0.3 | 0.61 ± 0.01 | 4.9 ± 0.1 | 18 ± 0.2 |
| 28736 | 0.63 ± 0.02 | 31 ± 1 | 0.45 ± 0.02 | 6.9 ± 0.4 | 21 ± 0.4 |

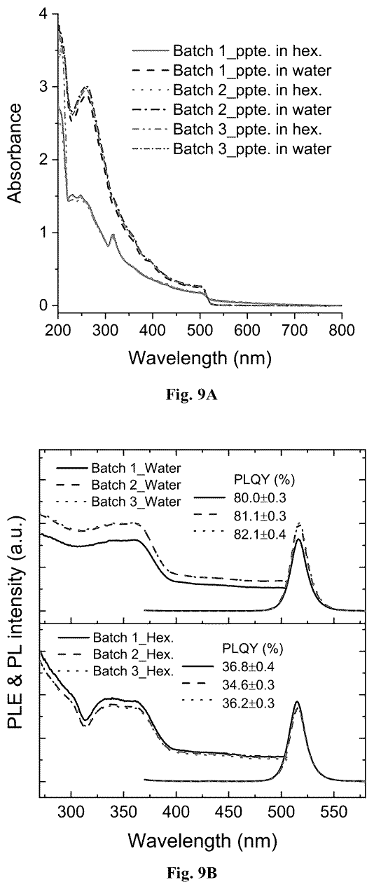

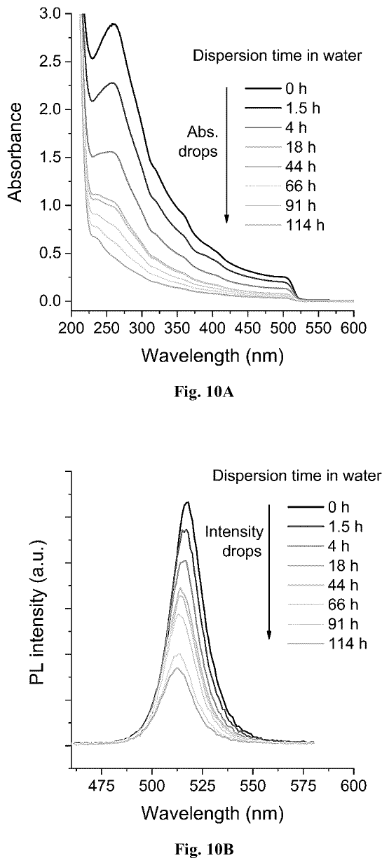

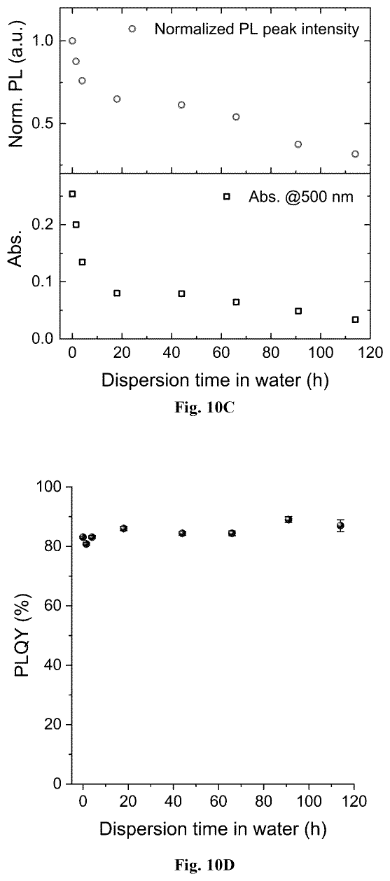

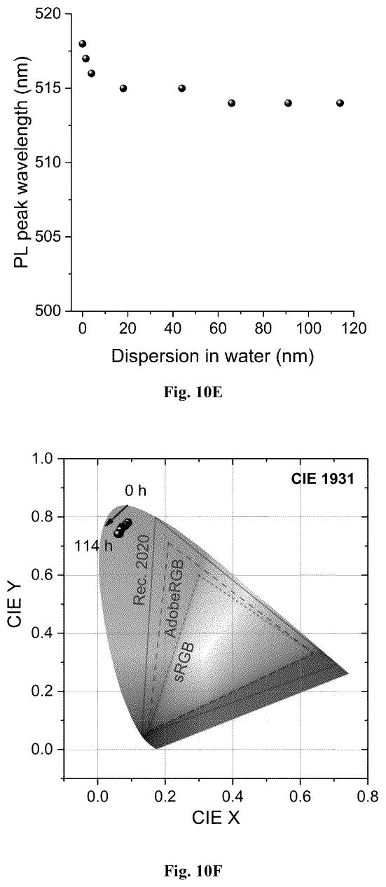

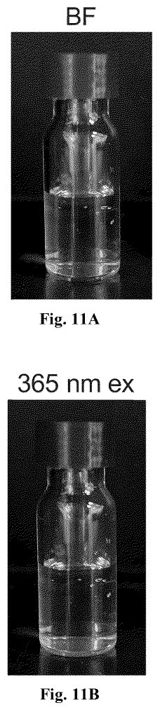

Remarkably, at an optimal Rₘ˜5,747, the sample reached peak PL intensity and brightness, maintaining an impressive PLQY of ≥80% (FIGS. 9A and 9B) even after 10,300 hours in water (stored at 4° C. and tested at room temperature, FIG. 7E), though the absolute absorption and PL intensity decreased, indicating gradual degradation (FIGS. 10A to 10F). Nevertheless, the sustained high PLQY and long PL lifetime suggest effective surface passivation and protection.

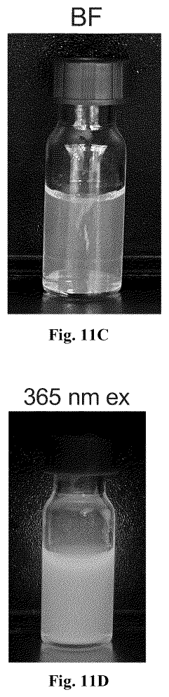

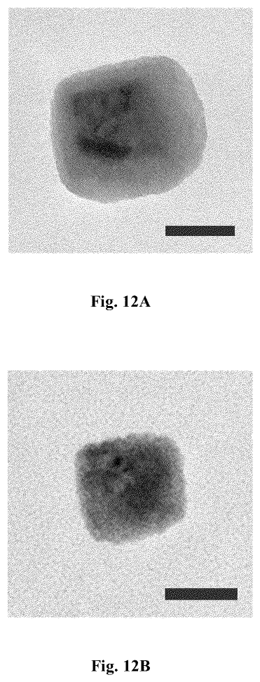

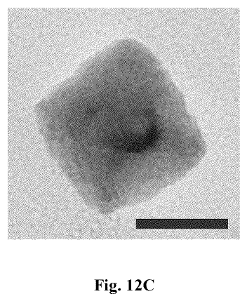

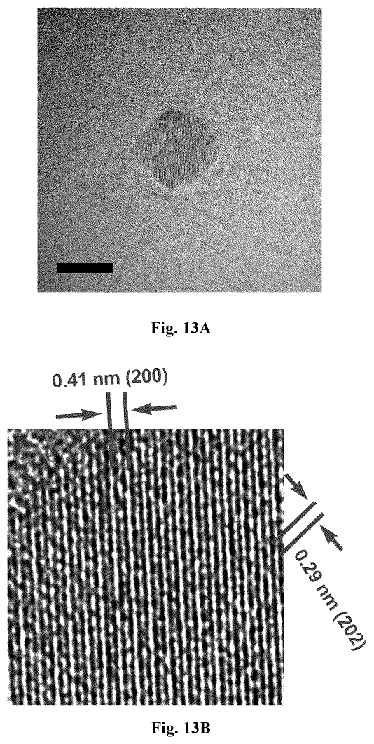

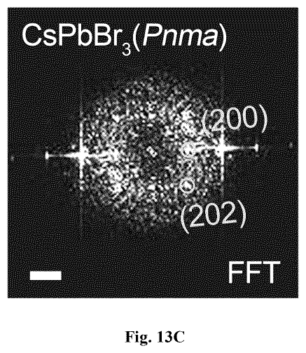

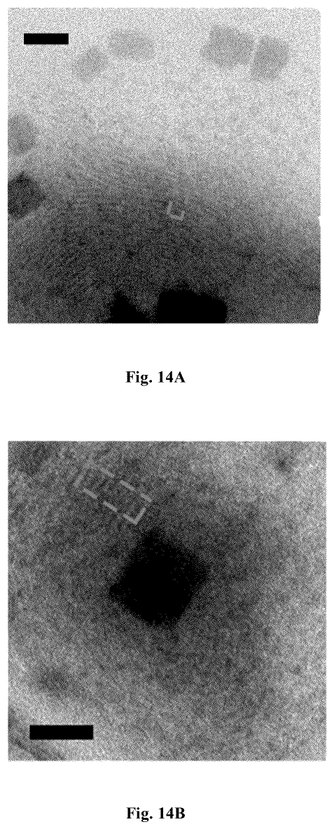

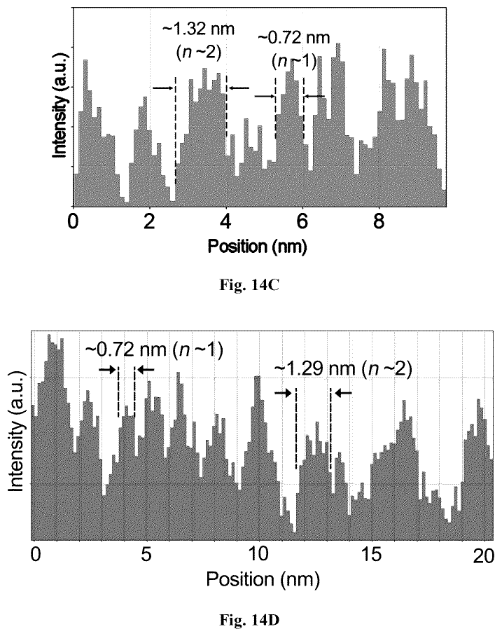

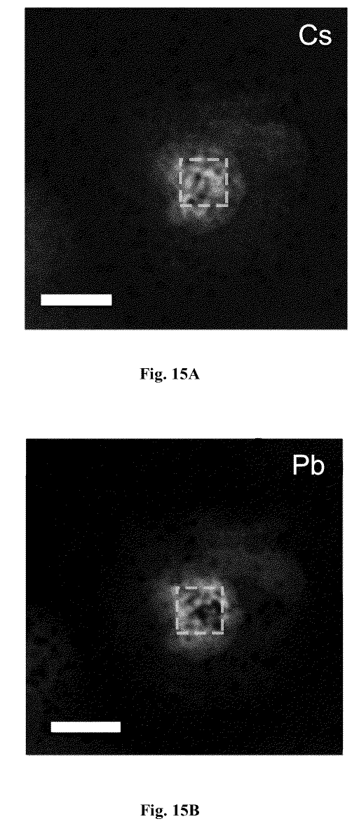

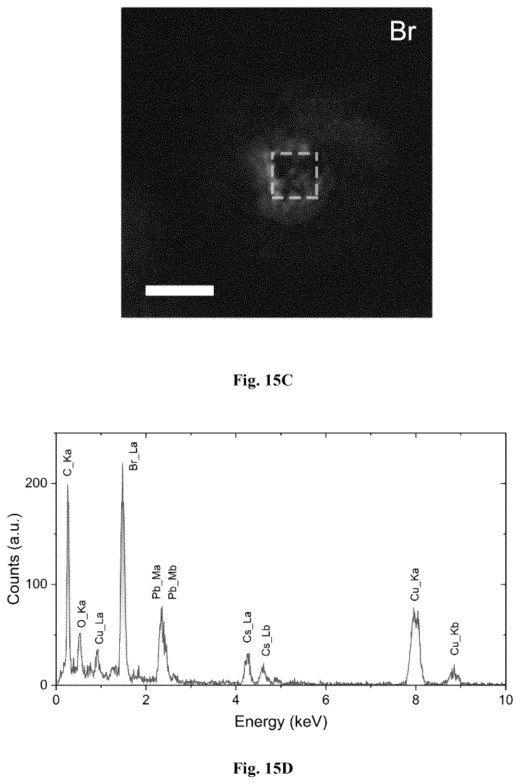

The enhanced water stability of these treated HPNCs is attributed to a unique stabilization mechanism. Untreated HPNCs generally lose their emission and do not disperse well in water (FIGS. 11A and 11B), while the OAmBr-treated HPNCs with Rₘ spanning from 1,149 to 28,736, formed clear and distinct green solutions (represented by the sample with Rₘ=5,747, FIGS. 11C and 11D) with high zeta potential (70-92 mV, FIG. 7F), suggesting excellent dispersion stability with positively charged surfaces. In situ liquid-cell TEM images revealed a monodisperse core-shell structure, with a high-contrast core surrounded by a lighter shell (FIG. 7G, FIGS. 12A to 12C). HRTEM confirmed that the core retained the 3D-phase Pnma structure (imaged in the [010] direction, FIGS. 13A to 13C), while the shell exhibited layered structures upon water evaporation (FIGS. 14A to 14D). The representative nanocrystal (after water evaporation) was also imaged using high-angle annular dark-field (HAADF) scanning TEM (STEM) mode coupled with energy dispersive X-ray spectroscopy (EDX) to map the composition (FIGS. 15A to 15D).

TABLE 3
EDX quantification for the elements Cs, Pb and Br.

| Atoms | Atomic (%) |
|---|---|
| Cs | 27.0 |
| Pb | 15.6 |
| Br | 57.5 |

EDX atomic % was calculated by using Cliff-Lorimer method. The k factors were taken from the k-factor library in the JEOL software. The data was collected using JED-2300 detector and analysis station. The raw data was then extracted and analysed using Hyperspy.

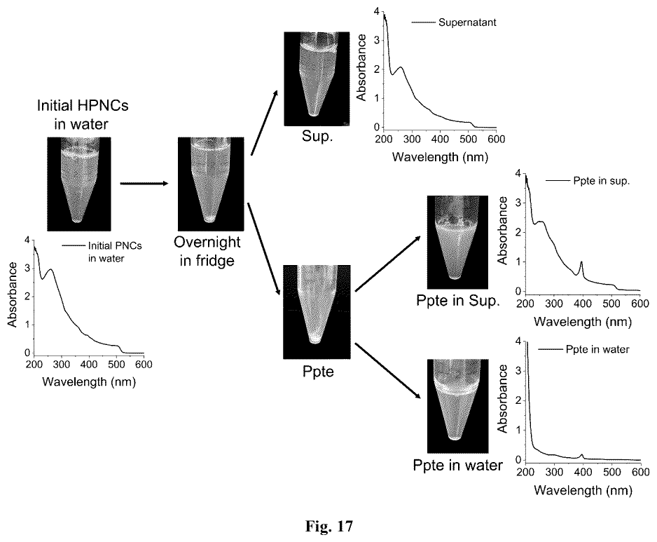

Cs, Pb, and Br were detected with an approximate atomic ratio of 2:1:4, indicating that the 3D phase exists in a CsBr-rich environment, although the presence of [PbBr₄]²⁻ species cannot be excluded. The optical and structural features of high Rₘ samples revealed additional spectral peaks (˜396 nm and emissions at ˜403 nm and 435 nm) and structural evidence for [PbBr₄]²⁻ based species (FIGS. 7A, 7B, 16A, 16B and 17), such as layered structures L₂Csₙ₋₁PbₙBr₃ₙ₊₁ (n=1, 2) after water dispersion. Under low temperature storage, the HPNCs aqueous solution is prone to precipitate the [PbBr₄]²⁻ based species, with absorption peaks at around 396 nm.

In the aqueous system, when the concentration of [PbBr₄]²⁻ is sufficiently high or after water evaporation under the presence of OAm⁺, the following structural transformations may occur:

$${[ {PbBr}_{4} ]}^{2 -} + 2 {OAm}^{+} \to {( OAm )}_{2} {PbBr}_{4} ( n = 1 , RPP ) \qquad ( 3 )$$

$${{( OAm )}_{2} [ PbBr ]}_{4} + {CsPbBr}_{3} \to {( OAm )}_{2} {CsPb}_{2} {Br}_{7} ( n = 2 , RPP ) \qquad ( 4 )$$

TEM measurement of the aqueous sample after water evaporation further confirmed the existence of these layered structures surrounding the cuboidal shaped core NC (FIGS. 14A and 14B). In the TEM images, the regions with higher contrast indicate areas where the electron beam is less transmissive. These regions correspond to the thickness of the 2D [PbBr₄]²⁻ framework itself, without including the organic OAm bilayer. The OAm bilayer appears nearly transparent in conventional TEM images because the electron beam can easily pass through it, making it practically invisible.

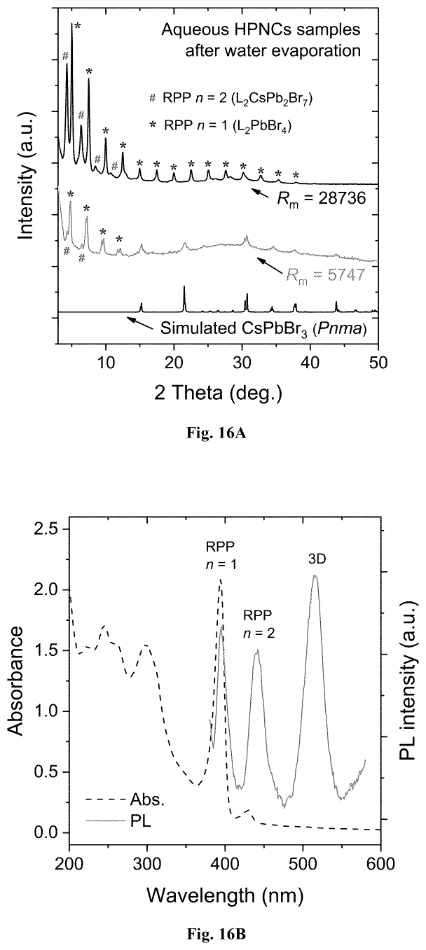

Based on the above, the thickness of the 2D layered structure was calculated to be about 0.7 nm to 1.4 nm, which corresponds to the thickness of L₂Csₙ₋₁PbₙBr₃ₙ₊₁ for n=1 and n=2. The periodic diffraction peaks at small angles in PXRD (FIG. 16A) also revealed the presence of these layered structures, which are consistent with previous studies. This is especially after water evaporation, where both the characteristic absorption and emission of these layered structures can be observed. The absorption spectrum (FIG. 16B) well matches that of the reported [PbBr₄]²⁻ based low-dimensional structures (both peak shapes and high-energy peak positions), thus further supporting the proposed structural transformation.

Besides, the absorption peak at ˜314 nm attributed to the 0D phase disappeared in all samples as well as the fully converted 0D phase sample (Rₘ˜28,736) still exhibited the characteristic green emission from the 3D phase (FIGS. 7A, 7B, and 7D). These results suggest that during the water dispersion process, the 0D phase decomposed, and should have evolved in the presence of OAmBr as follows:

$${Cs}_{4} {Pb Br}_{6} \to {CsPbBr}_{3} + 3 {Cs}^{+} + 3 {Br}^{-} \qquad ( 5 )$$

$${Cs}_{4} {Pb Br}_{6} + 2 OAmBr \to {( OAm )}_{2} [ {PbBr}_{4} ] + 4 {Cs}^{+} + {4 Br}^{-} \qquad ( 6 )$$

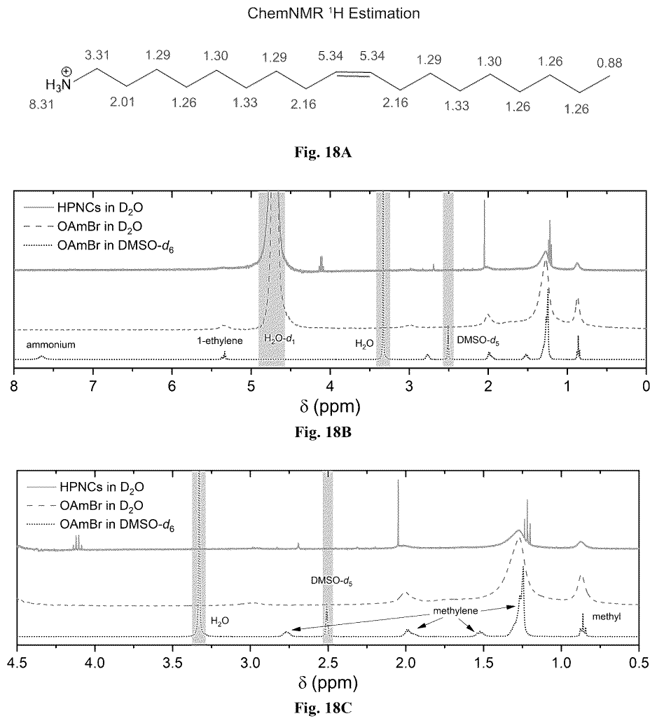

Initially, OAmBr served as a surface ligand for the NCs, linking to both 0D and 3D phases. In water, the 0D phase dissolved, producing (OAm)₂ [PbBr₄] with OAmBr that spontaneously assembled around the 3D NCs to create a stabilizing OAm⁺-bilayer/2D/OAm⁺-bilayer shell (2D=[PbBr₄²⁻] anion based structures, i.e., Csₙ₋₁PbₙBr₃ₙ₊₁²⁻ for n=1 or n=2). This unique shell structure minimized the high surface energy associated with the hydrophobic ends of OAm⁺ chains (FIG. 7H). The process is further supported by the faster water-induced breakdown of the 0D phase compared to the 3D phase due to the high ionic diffusion properties conferred by the independent [PbBr₆]4⁻ structure. To confirm the formation of the bilayer structure, a nuclear magnetic resonance (NMR) analysis of OAmBr in various states was conducted (FIGS. 18B and 18C) and compared with the predicted ¹H chemical shifts (FIG. 18A).

In DMSO-d6, OAmBr was fully dissolved, yielding sharp peaks with distinct splitting. In contrast, in D₂O, poor dispersion led to broader peaks with reduced splitting, and a downfield shift of the signal (toward higher ppm value) due to enhanced deshielding of C—H protons by the interaction with water. While as a nanocrystal ligand and forming bilayer structures in D₂O, improved dispersion produced moderately broadened peaks. Furthermore, the subtle splitting peaks observed at the methylene positions indicate that the mobility of these hydrophobic segments and the uniformity of their local magnetic environment have been enhanced, reflecting the ordered arrangement and partially constrained conformation of the OAmBr molecules in the formation of a bilayer structure, rather than as a disordered aggregation.

Exposed —NH₃⁺ groups on the OAm⁺-bilayer in the shell structure rendered the entire surface of the core-shell nanoparticles positively charged, consistent with the positive zeta potential measurements. The amount of (OAm)₂[PbBr₄] generated—and thus the compactness of the shell—depends on the initial quantities of 0D phase and OAmBr, explaining the varied stability and luminescence observed across treatment levels.

### Example 3: PH and Dilution Dependent Optical Performance of Perovskite Nanocrystals

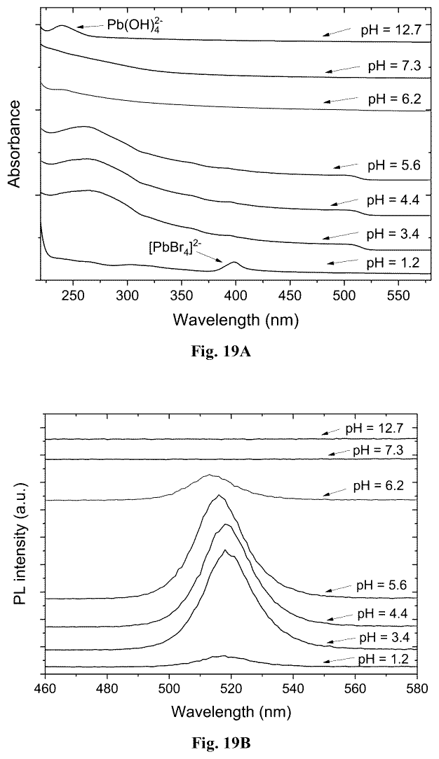

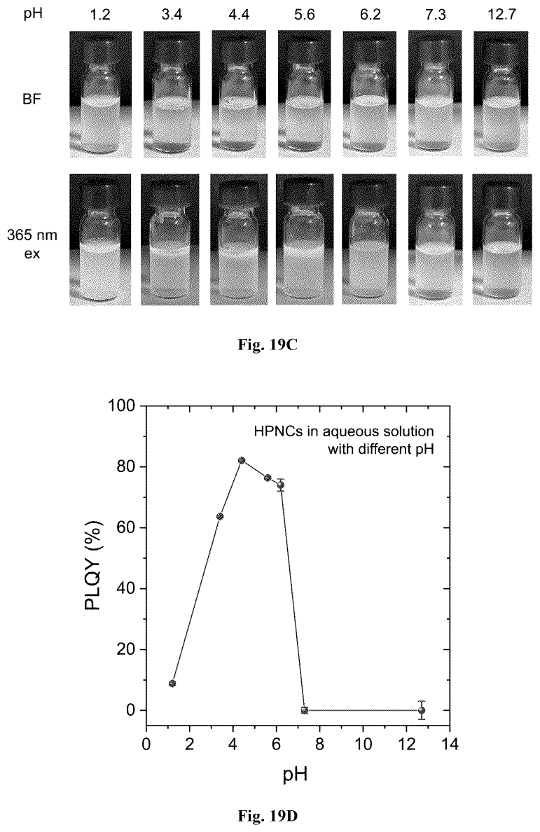

Solid-state HPNC samples (treated with OAmBr at Rₘ=5,747 and purified) were dispersed in HBr and CsOH solutions to control pH without introducing ions foreign to CsPbBr₃ to explore pH-dependent optical properties of aqueous HPNCs (FIGS. 19A to 19D). Results showed that these HPNCs remained stable with over 60% PLQY in acidic conditions, specifically between pH=3 and 6. In pure distilled water (pH ˜4.4 due to OAm⁺ hydrolysis), they achieved their highest PLQY (>80%). When pH rose above 6, however, PLQY quickly dropped, along with a colour shift from yellow-green to colourless and a blue-shifted, weakened PL emission. This behavior suggests the reversible hydrolysis of OAm⁺, i.e., OAm⁺+H₂O⇄OAmOH+H⁺, which destabilized the protective shell at higher pH, causing 3D phase degradation.

In a strong acidic environment (pH=1.2), the HPNCs aqueous solution exhibited a significant absorption peak at around 397 nm, corresponding to [PbBr₄]²⁻ based species, while in a strong alkaline environment (pH=12.7), the aqueous solution showed an absorption peak at around 240 nm, corresponding to Pb(OH)₄²⁻ species. pH values were tuned by CsOH and HBr aqueous solution to reduce the additional influence of other element ions not constituting CsPbBr₃. The results showed that HPNCs samples are stable in acidic solution. The pH value of pure distilled water dispersed HPNCs sample is about 4.4, which should be due to the hydrolysis of the weak base cation OAm⁺.

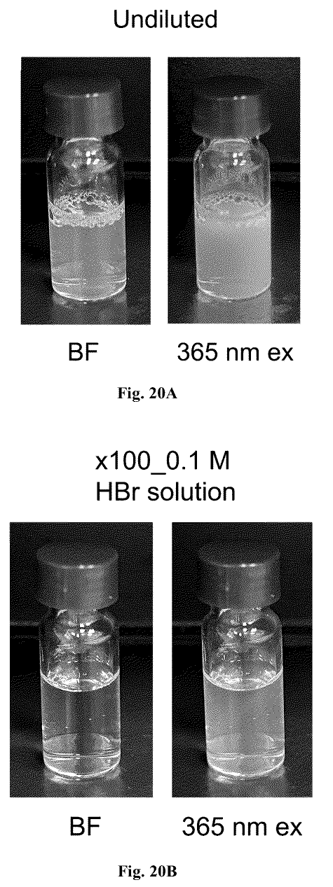

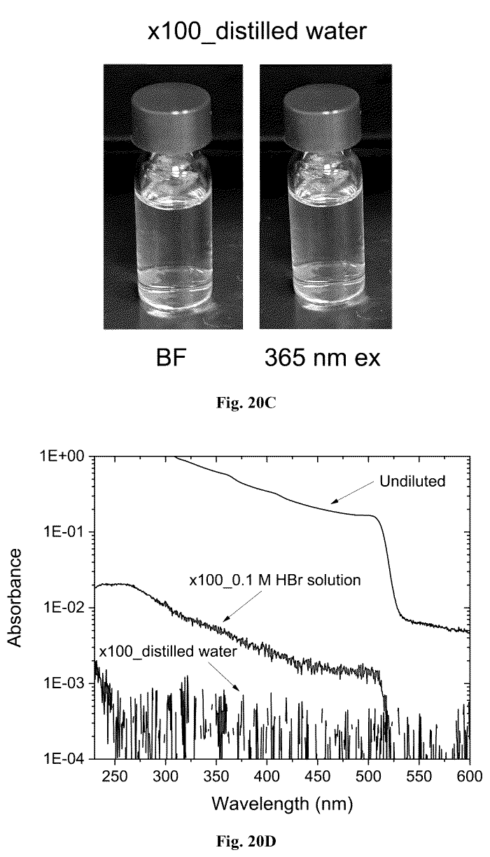

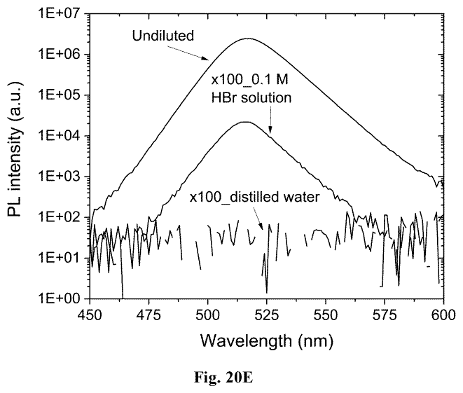

This pH-sensitive stability also allowed the preparation of highly diluted HPNCs solutions in acidic media. For instance, by diluting freshly prepared aqueous HPNCs solution using 0.1 M HBr solution (100-fold to ˜1.2 nM), their distinct absorption and PL emission were preserved, with the optical properties scaling predictably with dilution (FIGS. 20A to 20E). In contrast, diluting with distilled water caused a rapid loss of optical features. Attempts to directly dissolve HPNCs powder in strong acid (0.1 M HBr) led to reduced luminescence and dispersibility (FIGS. 19A to 19D), likely due to acid-induced breakdown of the 3D phase structure before the shell could fully form, highlighting the importance of effective shell establishment for stable optical performance.

No light absorption or emission was observed after diluting the initial HPNCs aqueous solution 100 times with pure distilled water. In contrast, after a 100× dilution with 0.1 M HBr solution, distinguishable light absorption and emission was still observed, and the corresponding intensity decrease was approximated to 100 times, indicating that this dilution method does not further damage the nanocrystals.

### Example 4: Single Photon Emission of Perovskite Nanocrystals in Aqueous Phase

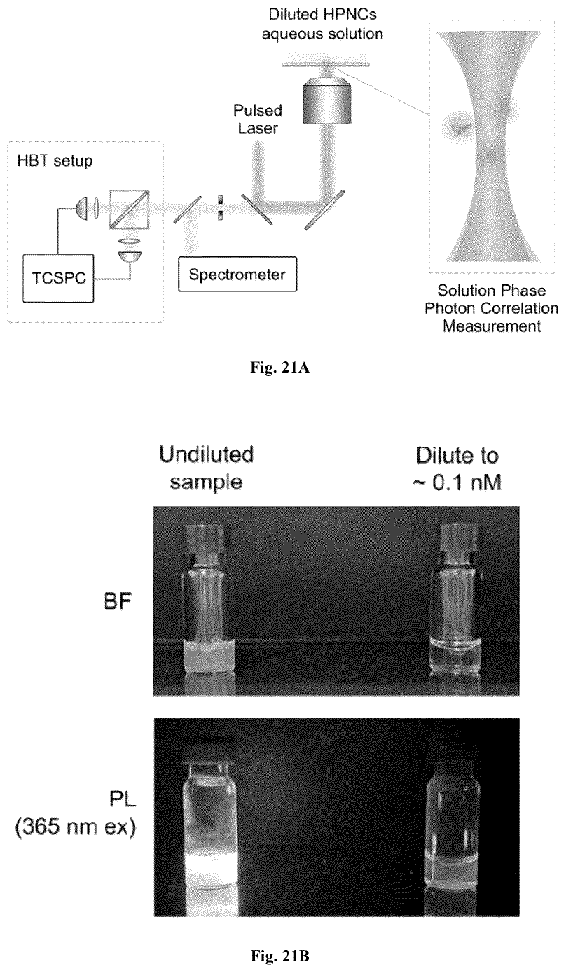

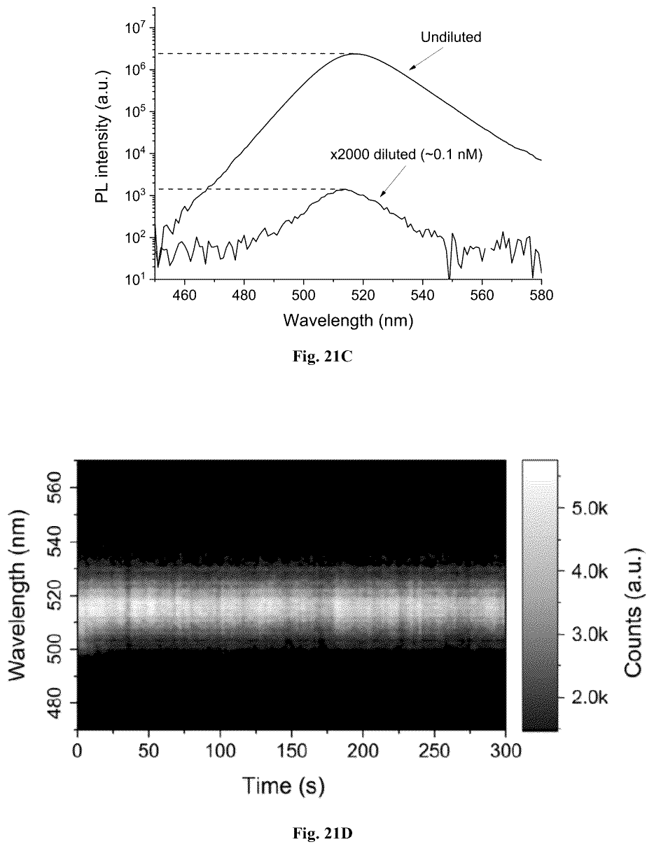

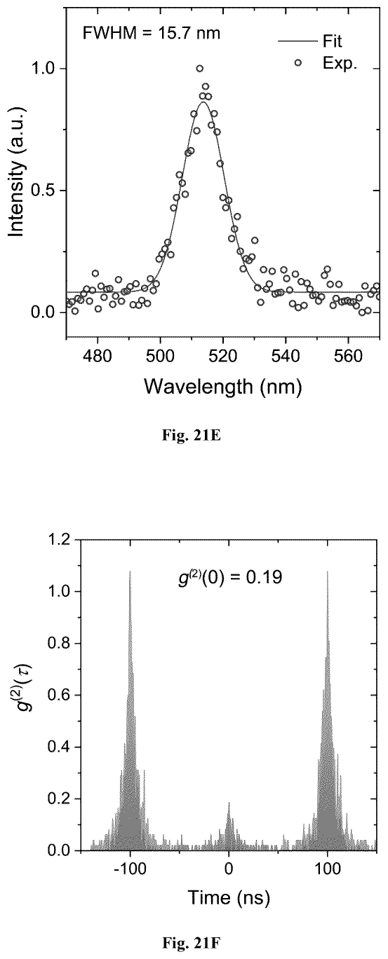

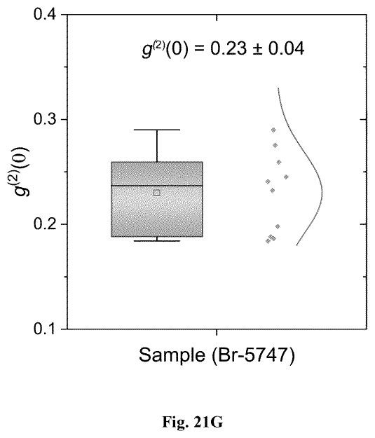

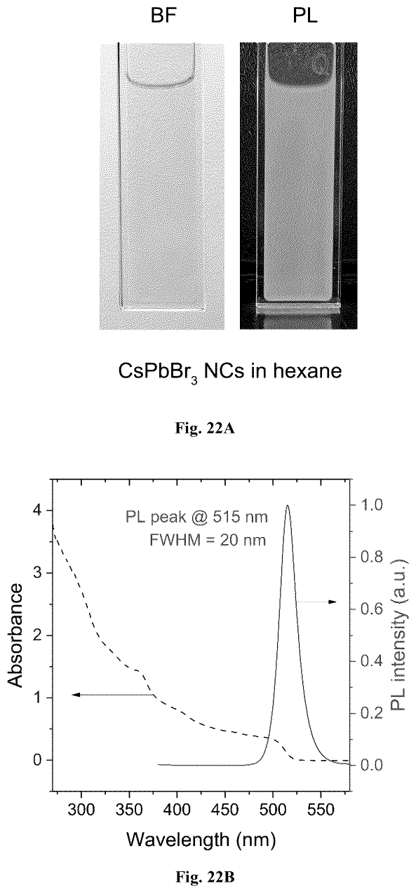

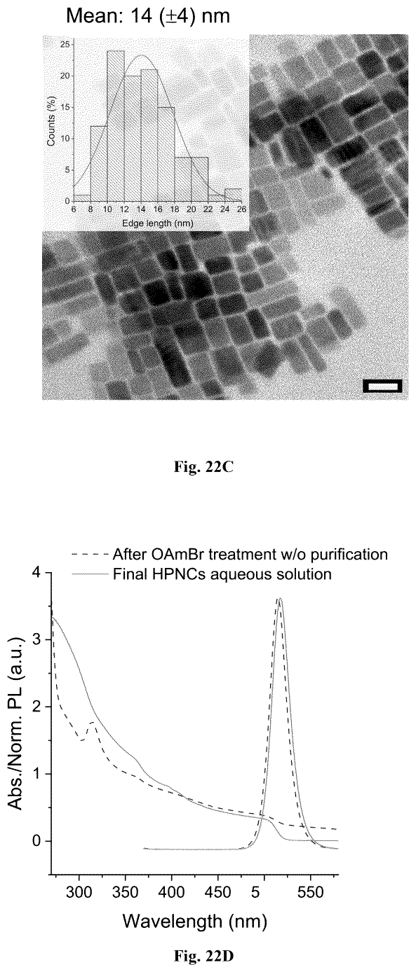

In organic solutions, photon correlation measurements have previously been used to examine the average biexciton/exciton quantum yield ratio at the ensemble level, giving insight into single-photon purity. The solution phased photon correlation S-g⁽²⁾ experimental setup is shown in FIG. 21A. Recognizing that smaller NCs generally enhance single-photon purity, the synthesis was adjusted to produce smaller aqueous HPNCs by reducing the average size of initial template CsPbBr₃ NCs from −17 nm to −14 nm (FIGS. 22A to 22D). These modified HPNCs also maintained excellent optical properties in water, even at ultra-high dilution levels (˜0.1 nM, FIGS. 21B and 21C). The highly diluted aqueous samples were excited under a confocal inverted fluorescence microscope, and the emitted light was collected and, in addition to performing spectral measurements, split into two channels in a Hanbury Brown and Twiss (HBT) configuration, and detected by two avalanche photodiodes. The S-g⁽²⁾ results revealed spectrally stable and narrow PL (FIGS. 21D to 21E and 23A to 23B) and high single-photon purity in aqueous solution.

The samples showed good spectral stability without distinct peak shifts 0.1 M HBr aqueous solution was used to dilute the HPNCs aqueous solution 2,000 times. 10 MHz, 475 nm pulsed laser with pulse width<70 ps was used to excite the diluted aqueous sample, pump fluence ˜2 mJ/cm².

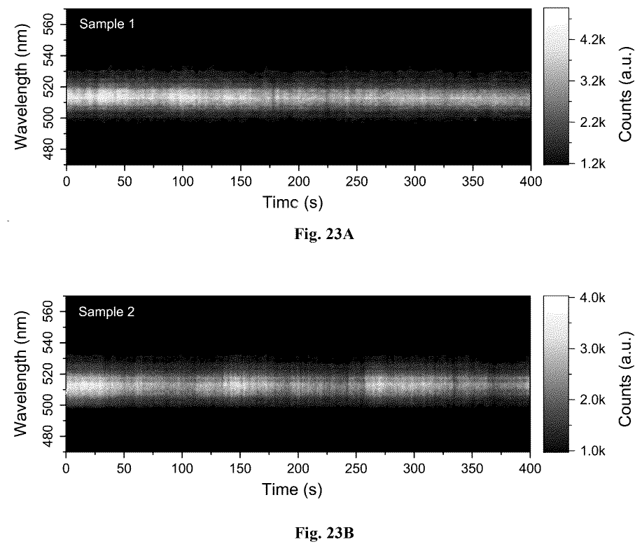

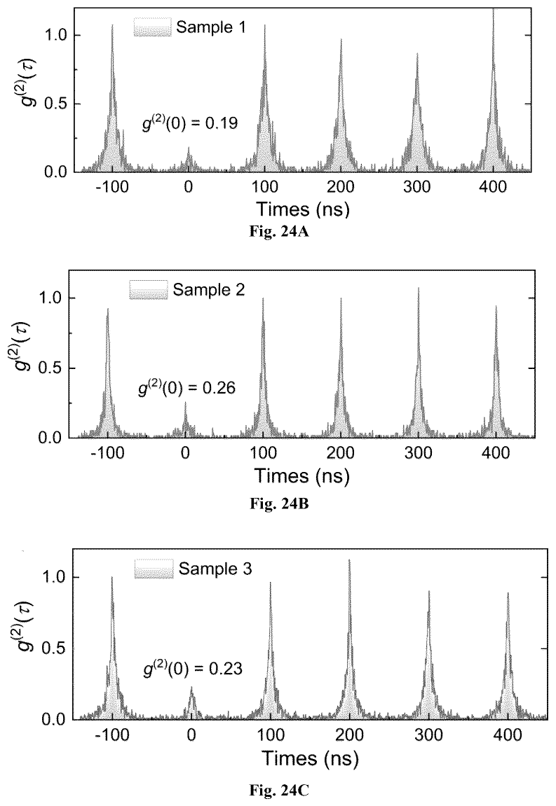

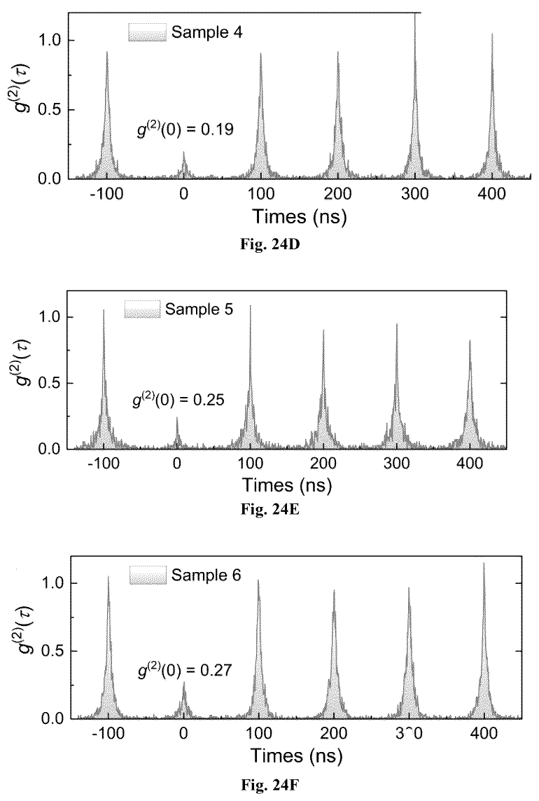

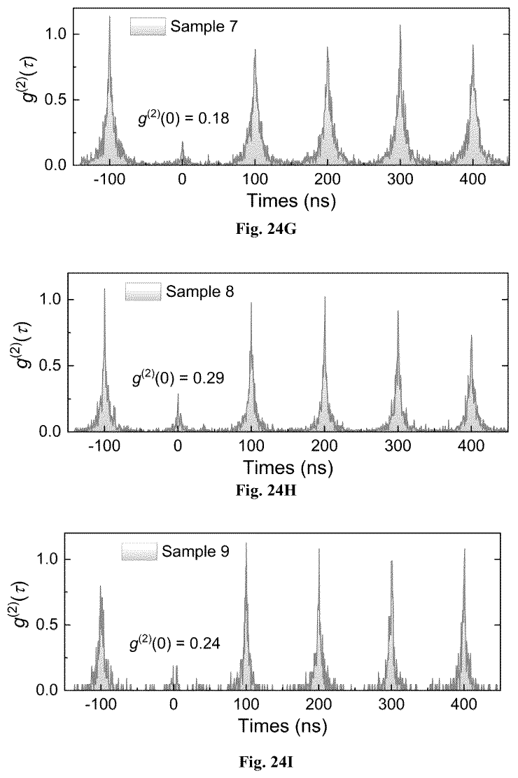

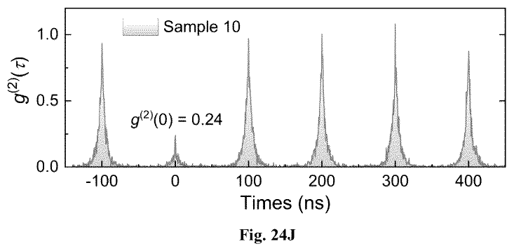

The second-order correlation function g⁽²⁾(τ) at zero delay time (τ=0), g⁽²⁾(0), reached a minimum of approximately 0.19 (FIG. 21F), with an average value of 0.23±0.04 (FIGS. 21G and 24A to 24J), indicating that the aqueous HPNCs met the criteria for water-phase quantum light sources. The samples showed distinct anti-bunching behaviours even at the ensemble level. 0.1 M HBr aqueous solution was used to dilute the HPNCs aqueous solution 2,000 times. 10 MHz, 475 nm pulsed laser with pulse width<70 ps was used to excite the diluted aqueous sample, pump fluence ˜2 μJ/cm².

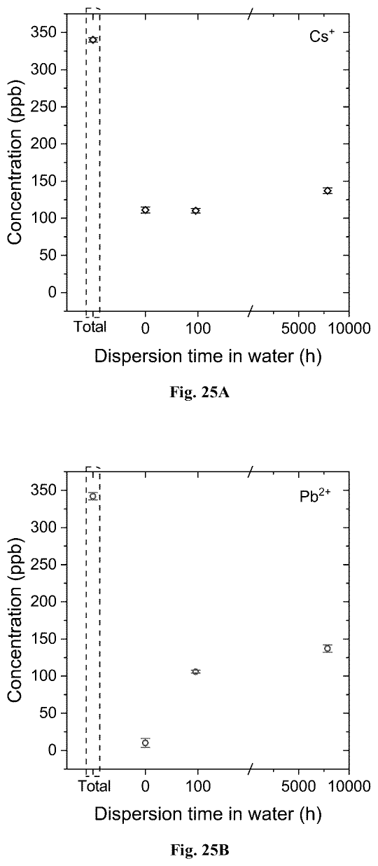

Lastly, the maximum free Pb²⁺ concentration in these QLS-level aqueous HPNCs solution was of several hundred parts per billion (ppb) (FIGS. 25A and 25B), far below the limits (1,000 ppm) imposed by the European Union's Restriction of Hazardous Substances (RoHS) Directive. In FIGS. 25A and 25B, ‘total’ represents the maximum amount of the relevant ions present in the system. This value was obtained by treating the aqueous HPNCs with nitric acid and overnight sonication, then followed by diluting with pure water to achieve the same dilution level as that used for the S-g⁽²⁾ experiment. After approximately 7,900 hours of nanocrystal dispersion in water, the free Pb ions (i.e., those originating from the degradation of the nanocrystals) in the system were only about 137±5 ppb. Even under the assumption that all the Pb in the system exists as free Pb ions, the content is about 340±5 ppb, which is far below the RoHS limit of 1,000 ppm for lead content. It is worth noting that even though the aqueous HPNCs solution samples presented for basic optical characterization had a concentration level about 1,000 times higher than the samples used for S-g⁽²⁾ experiments, it can be inferred that their maximum Pb content did not exceed 340 ppm, which is also below the RoHS standard.

### Example 5: Colour Tunability of Perovskite Nanocrystals in Aqueous Phase

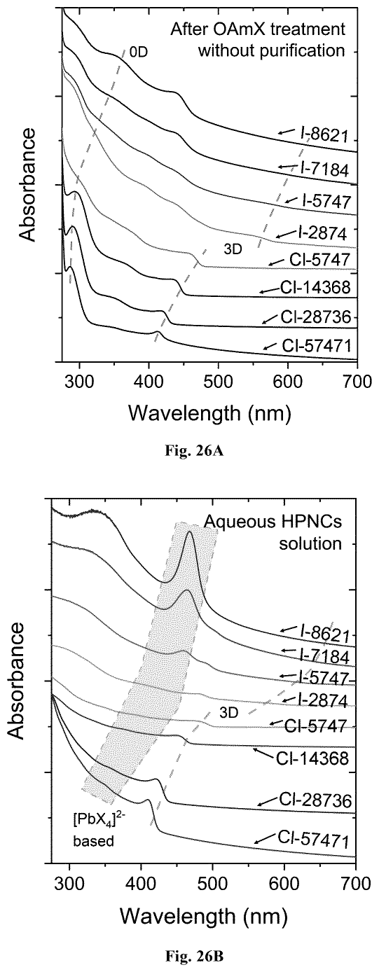

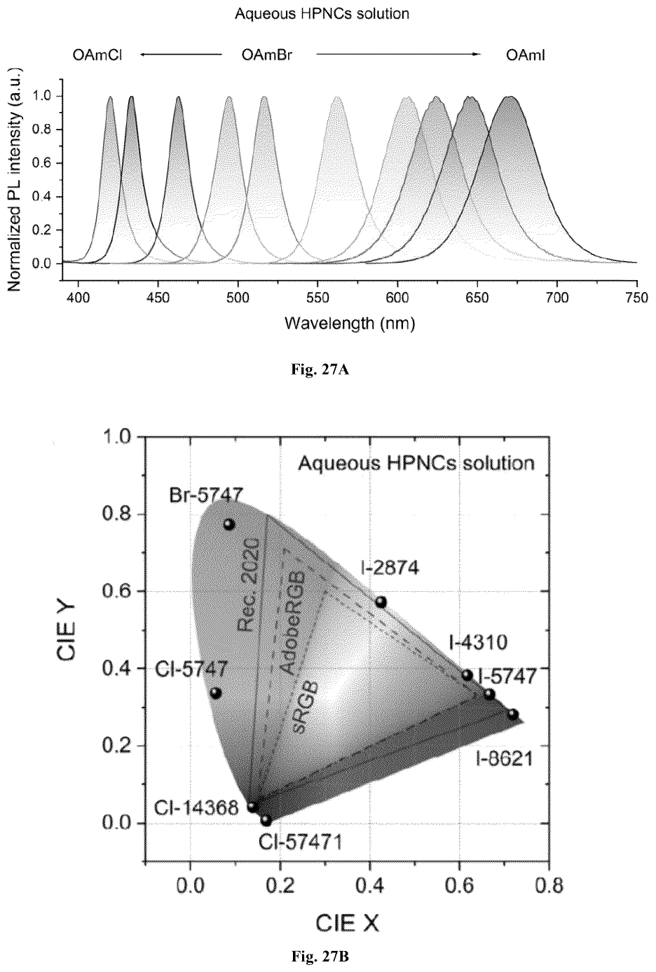

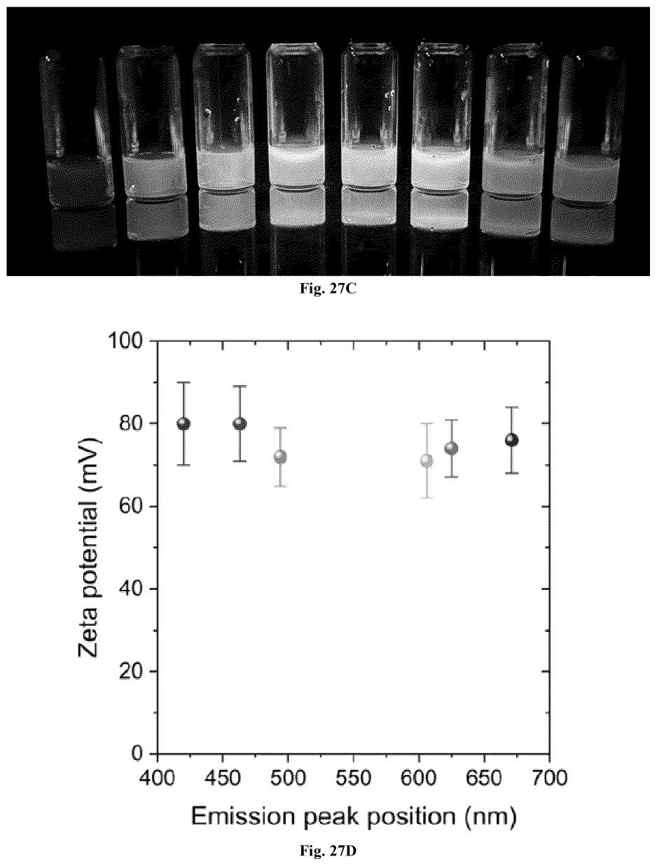

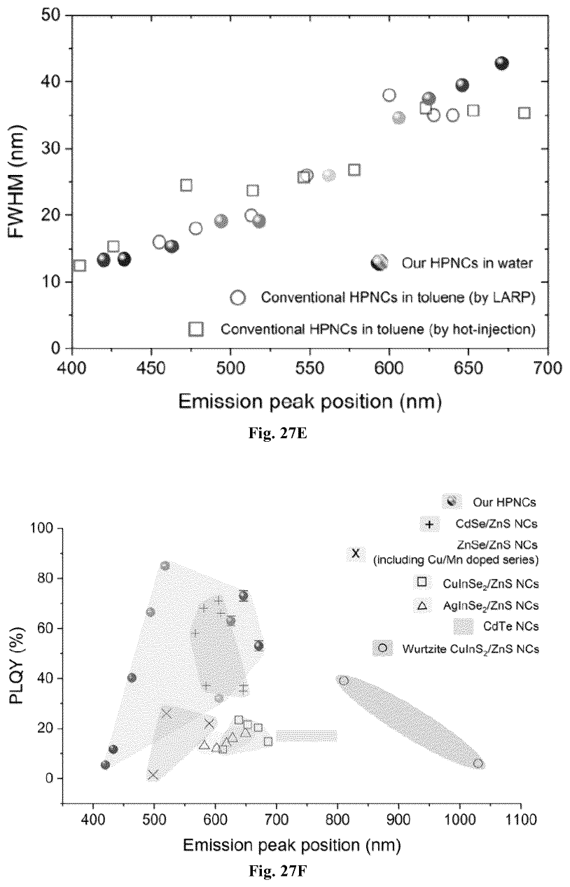

Full colour tuning was achieved by post-treating template CsPbBr₃ NCs with different Rₘ of OAmCl or OAmI, similar to the OAmBr treatment approach. Absorption spectra confirmed that these treatments transformed 3D CsPbBr₃ NCs into mixed-halide (X═Cl/Br or Br/I) 0D Cs₄PbX₆ NCs (FIG. 26A), with absorption peaks shifting farthest to ˜286 nm for OAmCl treatment (Rₘ˜57,471) and ˜360 nm for OAmI treatment (Rₘ˜8,621), close to pure Cs₄PbCl₆ and Cs₄PbI₆ (284 nm and 367 nm, respectively). After dispersing these treated HPNCs in water (FIGS. 26B and 27D), the retention of the 3D phase, disappearance of the 0D phase, formation of [PbX₄]²⁻ species, and stable dispersion with a high positive zeta potential (>70 mV) suggest that OAmX (X═Cl, Br, I) post-treatment enabled a consistent structural transformation and water stabilization mechanism. These HPNCs offered a near-complete Rec. 2020 colour space coverage, with tuneable emissions from −420 nm to −670 nm and high colour purity (narrow bandwidth) (FIGS. 27A to 27C). PLQY generally remained high (40-80%), though samples treated with high Rₘ ratios showed some reduction (FIG. 27F), attributed to factors like trap-mediated non-radiative losses and crystalline phase instability in mixed halide perovskites. Notably, iodine-treated HPNCs reached up to 73% PLQY (Rₘ=7,184), overcoming typical moisture-induced quenching in iodide perovskites.

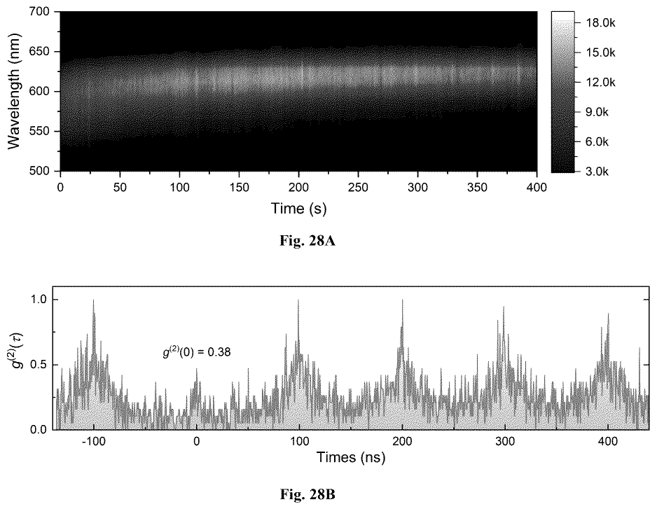

Lastly, red or near-infrared emitting aqueous nanocrystals hold great promise as quantum light sources in opto-fluidics applications. This can be especially challenging under highly dilute conditions for iodide-based HPNCs which are well-known to be less stable than the green emitters. Despite undergoing a 2,000-fold dilution, the disclosed red-emitting aqueous HPNCs exhibited aqueous solution phase single photon emission with a g⁽²⁾(0) value of 0.38 (<0.5) (FIGS. 28A and 28B). A tendency was shown for the PL peak position to gradually redshift due to the influence of dynamic anion exchange. The central wavelength eventually stabilized to −620 nm (FIG. 28A). This further exemplifies the exceptional protection provided by the disclosed in situ core-shell mechanism based on structural transformation. The samples of a preliminary solution phase g⁽²⁾ test of a representative diluted red-emitting HPNCs aqueous solution sample showed a distinct anti-bunching behaviour. 10 MHz, 475 nm pulsed laser with pulse width<70 ps was used to excite the diluted aqueous sample, pump fluence ˜3 μJ/cm² for the S-g⁽²⁾ test. 6 mM OAmBr and 3 mM OAmI was used mixed aqueous solution to dilute the HPNCs aqueous solution 2,000 times.

### Comparative Example 1

The HPNCs of Example 5 were compared to conventional organic-phase processing HPNCs (FIGS. 27E and 27F). These resultant aqueous HPNCs present by far the brightest stable water soluble NCs series with widest emission colour gamut (Table 4).

TABLE 4
Comparison of conventional water dispersible NCs.

| Materials | λₑₘ^{a} (nm) | η^{b} (%) |
|---|---|---|
| HPNCs in water | 420-671 | 5.4-85 |
| CdSe/ZnS NCs in water | 567-646 | 35-71 |
| ZnSe/ZnS NCs and their Cu/Mn doped | 498-590 | 1.5-26 |
| series in water | | |
| CuInSe₂/ZnS and AgInSe₂/ZnS NCs in | 582-686 | 10.1-23.3 |
| aqueous solution | | |
| CdTe NCs in aqueous solution | 700-800 | 15-20 |
| Wurtzite CuInS₂/ZnS NCs in water | 810-1030 | 6-39 |

^{a}λₑₘ refers to the emission centre wavelength of the material.
^{b}η refers to the PLQY.

### INDUSTRIAL APPLICABILITY

The present invention relates to perovskite nanocrystal particles for use in polar protic solvents, particularly water. The perovskite nanocrystal particles of the present invention possess high brightness, mono-dispersibility, and enhanced stability in water, even at ultra-low concentrations. The disclosed particles may also serve as blinking-free single photon sources, and water phase single photon emission for quantum technologies. Thus, this invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A particle having a core-shell structure, wherein the core comprises a perovskite compound CsPbX₃, and the shell comprises Csₙ₋₁PbₙX₃ₙ₊₁²⁻ and at least one organic ammonium cation R¹R²R³R⁴N⁺,
wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X is a halide.

2. The particle of claim 1, wherein the shell comprises the organic ammonium cation as a bilayer.

3. The particle of claim 2, wherein the shell comprises a perovskite compound having a formula of (R¹R²R³R⁴N)₂Csₙ₋₁PbₙX₃ₙ₊₁.

4. The particle of claim 2, wherein the shell has a configuration of R¹R²R³R⁴N⁺ bilayer|Csₙ₋₁PbₙX₃ₙ₊₁²⁻|R¹R²R³R⁴N⁺ bilayer.

5. The particle of claim 1, wherein the particle is dispersed in a polar protic solvent.

6. The particle of claim 5, wherein the solvent is water.

7. The particle of claim 1, wherein the CsPbX₃ and the Csₙ₋₁PbₙX₃ₙ₊₁²⁻ are present in a molar ratio satisfying the following equation
$$0 < {CsPb X}_{3} / ( {CsPb X}_{3} + {Cs}_{n - 1} {Pb}_{n} {X}_{3 n + 1}^{2 -} ) \leq 0.98 .$$

8. The particle of claim 1, wherein R¹ is selected from the group consisting of cis-9-octadecen-1-yl, phenethyl, benzyl, or naphthylmethyl; and R², R³, R⁴ are each independently selected from the group consisting of —H, cis-9-octadecen-1-yl, phenethyl, benzyl, or naphthylmethyl.

9. The particle of claim 8, wherein R¹ is cis-9-octadecen-1-yl and R², R³, and R⁴ are H.

10. The particle of claim 1, wherein the halide in CsPbX₃ and in Csₙ₋₁PbₙX₃ₙ₊₁²⁻ is the same.

11. The particle of claim 5, wherein the particle is dispersed in the solvent at a concentration from about 0.1 nM to about 1000 nM.

12. The particle of claim 5, wherein the solvent having the dispersed particle has a pH of about 1 to about 7.

13. The particle of claim 1, wherein the perovskite compound has a size of about 10 nm to about 21 nm.

14. The particle of claim 1, wherein in the core, the perovskite compound is CsPbBr₃, and in the shell, the Csₙ₋₁PbₙX₃ₙ₊₁²⁻ is Csₙ₋₁PbₙBr₃ₙ₊₁²⁻ and the at least one organic ammonium cation R¹R²R³R⁴N⁺ is an oleylammonium cation bilayer.

15. A method of passivating a perovskite compound CsPbX₃, the method comprising the step of:
a) adding an organic ammonium halide R¹R²R³R⁴NY to the CsPbX₃ at a molar ratio of R¹R²R³R⁴NY:CsPbX₃ of about 500:1 to about 60000:1 to form a mixture,
wherein
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X and Y are independently a halide.

16. The method of claim 15, further comprising the step of:
b) stirring the mixture for about 2 hours.

17. The method of claim 15, further comprising the step of:
c) adding at least one solvent, and centrifuging the resulting mixture to obtain a precipitate.

18. The method of claim 15, further comprising the step of:
d) dispersing the passivated perovskite compound in a polar protic solvent.

19. The method of claim 18, wherein the solvent is water.

20. A particle having a core shell structure produced by the method of claim 15,
wherein the core comprises a perovskite compound CsPbX₃, and the shell comprises Csₙ₋₁PbₙX₃ₙ₊₁²⁻ and at least one organic ammonium cation R¹R²R³R⁴N⁺,
wherein
n is 1 or 2;
R¹ is selected from the group consisting of optionally substituted alkyl, optionally substituted alkenyl, optionally substituted alkynyl, optionally substituted aryl, optionally substituted arylalkyl, and optionally substituted heteroaryl;
R², R³, and R⁴ are each independently selected from the group consisting of —H, optionally substituted alkyl, optionally substituted alkenyl, optionally substituted alkynyl, optionally substituted aryl, optionally substituted arylalkyl, and optionally substituted heteroaryl;
and
X is a halide.
